(19) United States
(12) Patent Application Publication
(10) Pub. No.: US 2023/0392739 A1
(43) Pub. Date: Dec. 7, 2023

(54) FLUID PULSATION DAMPENERS

(71) Applicant: BLACOH FLUID CONTROLS, INC., Riverside, CA (US)

(72) Inventors: David Dean McComb, Highland, CA (US); Daniel Michael Martinez, Rancho Cucamonga, CA (US)

(21) Appl. No.: 18/330,217

(22) Filed: Jun. 6, 2023

Related U.S. Application Data
(60) Provisional application No. 63/365,998, filed on Jun. 7, 2022.

(51) Int. Cl. F16L 55/05

(52) U.S. Cl. CPC F16L 55/05

(57) ABSTRACT

A pulsation dampener includes: a housing having a fluid port and a fluid chamber that is in fluid communication with the fluid port; a deformable member in fluid communication with the fluid chamber; a spring; and a linkage assembly that transfers a force between the deformable member and the spring, wherein the linkage assembly is configured to amplify the force between the deformable member and the spring.

### CROSS-REFERENCE TO RELATED APPLICATIONS

This application claims the benefit of U.S. Provisional Application No. 63/365,998, titled FLUID PULSATION DAMPENERS, filed on Jun. 7, 2022, which is hereby incorporated by reference herein in its entirety.

### BACKGROUND

### Field

This disclosure generally relates to systems, methods, and devices for dampening pulsations in fluid piping systems.

### Description

Hydraulic systems, such as fluid piping systems, are used to transport fluid under pressure in various applications. A fluid pump used in such systems creates pulsations that can cause a number of issues, including wearing out components of the pump and other portions of the system over time. A fluid pulsation dampener can be used to smooth out the fluid flow by absorbing such pulsations and providing extra pressure when needed.

### SUMMARY

The disclosure herein provides various embodiments of fluid pulsation dampeners, including fluid pulsation dampeners that utilize mechanical springs and linkage mechanisms to regulate a fluid pumping system flow without the need of pressurized gases for pressure control.

According to some embodiments, a pulsation dampener comprises: a housing having one or more fluid ports for fluidly coupling the pulsation dampener to a fluid pumping system, the housing further comprising a fluid chamber in fluid communication with the one or more fluid ports; a diaphragm having a first side and a second side, the first side of the diaphragm being in fluid communication with the fluid chamber such that changes in pressure in the fluid chamber can cause the diaphragm to deform; a mechanical spring positioned within a cavity of the housing, the mechanical spring having a first end and a second end, the first end of the mechanical spring being engaged with an adjustment screw that is translatable along a length of the cavity of the housing to adjust a level of preload on the mechanical spring; and a linkage assembly coupling the diaphragm to the second end of the mechanical spring, the linkage assembly comprising: a diaphragm seat coupled to the second side of the diaphragm; a spring seat coupled to the second end of the mechanical spring; and a linkage that is pivotally coupled to the housing at a first pivot location, to the diaphragm seat at a second pivot location, and to the spring seat at a third pivot location, wherein a distance between the second pivot location and the first pivot location is greater than a distance between the third pivot location and the first pivot location, such that translation of the diaphragm seat with respect to the housing by a first magnitude will cause translation of the spring seat with respect to the housing by a second magnitude that is smaller than the first magnitude.

According to some embodiments, a pulsation dampener comprises: a housing having one or more fluid ports for fluidly coupling the pulsation dampener to a fluid pumping system, the housing further comprising a fluid chamber in fluid communication with the one or more fluid ports; a deformable member having a first side and a second side, the first side of the deformable member being in fluid communication with the fluid chamber such that changes in pressure in the fluid chamber can cause the deformable member to deform; a spring having a first end and a second end; and a linkage assembly coupling the deformable member to the second end of the spring, the linkage assembly comprising: a first member coupled to the second side of the deformable member; a second member coupled to the second end of the spring; and a linkage that is pivotally coupled to the housing at a first pivot location, to the first member at a second pivot location, and to the second member at a third pivot location, wherein a distance between the second pivot location and the first pivot location is different than a distance between the third pivot location and the first pivot location, such that translation of the first member with respect to the housing by a first magnitude will cause translation of the second member with respect to the housing by a second magnitude that is different than the first magnitude.

In some embodiments, the deformable member comprises a diaphragm. In some embodiments, the spring comprises a mechanical spring. In some embodiments, the spring does not comprise pressurized gas. In some embodiments, the first end of the spring is coupled to an adjuster that enables adjustment of a level of preload on the spring. In some embodiments, the distance between the second pivot location and the first pivot location is greater than the distance between the third pivot location and the first pivot location, such that the second magnitude will be less than the first magnitude. In some embodiments, the distance between the second pivot location and the first pivot location is less than the distance between the third pivot location and the first pivot location, such that the second magnitude will be greater than the first magnitude.

According to some embodiments, a pulsation dampener comprises: a housing having a fluid port and a fluid chamber that is in fluid communication with the fluid port; a bellows that is in fluid communication with the fluid chamber, the bellows having a first end and a second end, the bellows configured such that the first end will translate with respect to the second end responsive to pressure changes within the fluid chamber; and a spring actuator assembly that resists expansion of the bellows, the spring actuator assembly comprising: a top plate that is fixed with respect to the housing; a bottom plate that is translatable with respect to the top plate, the bottom plate being engaged with the first end of the bellows such that translation of the first end of the bellows with respect to the second end of the bellows will cause translation of the bottom plate with respect to the top plate; a middle plate positioned between the top plate and the bottom plate, the middle plate being translatable with respect to both the top plate and the bottom plate; a plurality of springs positioned between the top plate and the middle plate, the plurality of springs providing a biasing force that biases the middle plate away from the top plate; and a plurality of linkage assemblies each comprising: a first link having a first end and a second end, the first end of the first link being pivotally coupled to the bottom plate; a second link having a first end and a second end, the first end of the second link being pivotally coupled to the top plate, and the second end of the first link being pivotally coupled to a portion of the second link between the first and second ends of the second link; and a third link having a first end and a second end, the first end of the third link being pivotally coupled to the second end of the second link, and the second end of the third link being pivotally coupled to the middle plate; wherein the plurality of linkage assemblies are configured such that translation of the bottom plate with respect to the top plate of a first magnitude will result in translation of the middle plate with respect to the top plate of a second magnitude, the second magnitude being greater than the first magnitude.

According to some embodiments, a pulsation dampener comprises: a housing having a fluid port and a fluid chamber that is in fluid communication with the fluid port; a deformable member that is in fluid communication with the fluid chamber, such that the deformable member at least partially defines a volume of the fluid chamber, and such that the deformable member will deform responsive to pressure changes within the fluid chamber; and a spring actuator assembly that resists deformation of the deformable member in a direction that increases the volume of the fluid chamber, the spring actuator assembly comprising: a top plate that is fixed with respect to the housing; a bottom plate that is translatable with respect to the top plate, the bottom plate being engaged directly or indirectly with the deformable member such that deformation of the deformable member will cause translation of the bottom plate with respect to the top plate; a middle plate positioned between the top plate and the bottom plate, the middle plate being translatable with respect to both the top plate and the bottom plate; a plurality of springs positioned between the top plate and the middle plate, the plurality of springs providing a biasing force that biases the middle plate away from the top plate; and a plurality of linkage assemblies each comprising: a first link having a first end and a second end, the first end of the first link being pivotally coupled to the bottom plate; a second link having a first end and a second end, the first end of the second link being pivotally coupled to the top plate, and the second end of the first link being pivotally coupled to a portion of the second link between the first and second ends of the second link; and a third link having a first end and a second end, the first end of the third link being pivotally coupled to the second end of the second link, and the second end of the third link being pivotally coupled to the middle plate; wherein the plurality of linkage assemblies are configured such that translation of the bottom plate with respect to the top plate of a first magnitude will result in translation of the middle plate with respect to the top plate of a second magnitude, the second magnitude being greater than the first magnitude.

In some embodiments, the deformable member comprises a bellows. In some embodiments, the deformable member comprises a diaphragm.

According to some embodiments, a pulsation dampener comprises: a housing having a fluid port and a fluid chamber that is in fluid communication with the fluid port; a deformable member that is in fluid communication with the fluid chamber, such that the deformable member will deform responsive to pressure changes within the fluid chamber; and a spring actuator assembly comprising: a first member connected to the housing; a second member that is translatable with respect to the first member, the second member being positioned such that deformation of the deformable member will cause translation of the second member with respect to the first member; a third member that is translatable with respect to both the first member and the second member; one or more springs positioned to provide a biasing force between the first member and the third member; and one or more linkage assemblies pivotally coupled to the first member, the second member, and the third member, the one or more linkage assemblies being configured such that translation of the second member with respect to the first member of a first magnitude will result in translation of the third member with respect to the first member of a second magnitude, the second magnitude being different than the first magnitude.

In some embodiments, the deformable member comprises a bellows. In some embodiments, the third member is positioned between the first member and the second member. In some embodiments, the one or more springs are positioned to bias the third member toward the deformable member. In some embodiments, the one or more springs comprise mechanical springs. In some embodiments, the one or more springs do not comprise pressurized gas. In some embodiments, the one or more linkage assemblies each comprise: a first link pivotally coupled to the second member; a second link pivotally coupled to the first member and the first link; and a third link pivotally coupled to the second link and the middle plate. In some embodiments, the second magnitude is greater than the first magnitude. In some embodiments, the one or more linkage assemblies are configured such that a relationship between translation of the second member with respect to the first member and translation of the third member with respect to the first member is non-linear.

According to some embodiments, a pulsation dampener comprises: a housing having a fluid port and a fluid chamber that is in fluid communication with the fluid port; a deformable member in fluid communication with the fluid chamber; a spring; and a linkage assembly that transfers a force between the deformable member and the spring, wherein the linkage assembly is configured to amplify the force between the deformable member and the spring.

In some embodiments, the force amplified by the linkage assembly is a force applied to the linkage assembly directly or indirectly by the spring. In some embodiments, the force amplified by the linkage assembly is a force applied to the linkage assembly directly or indirectly by the deformable member. In some embodiments, the linkage assembly comprises a first member that transfers the force to the spring, a second member that transfers the force to the deformable member, and one or more linkages that transfer the force between the first member and the second member. In some embodiments, the one or more linkages are configured to provide a mechanical advantage between the first member and the second member. In some embodiments, the deformable member comprises a diaphragm. In some embodiments, the deformable member comprises a bellows. In some embodiments, the pulsation dampener further comprises at least one additional spring and at least one additional linkage assembly. In some embodiments, the linkage assembly is configured such that a magnitude of amplification of the force between the deformable member and the spring varies depending on a position of the deformable member.

For purposes of this summary, certain aspects, advantages, and novel features of the inventions are described herein. It is to be understood that not necessarily all such advantages may be achieved in accordance with any particular embodiment of the inventions. Thus, for example, those skilled in the art will recognize that the inventions may be embodied or carried out in a manner that achieves one advantage or group of advantages as taught herein without necessarily achieving other advantages as may be taught or suggested herein.

### BRIEF DESCRIPTION OF THE DRAWINGS

The foregoing and other features, aspects, and advantages of the present disclosure are described in detail below with reference to the drawings of various embodiments, which are intended to illustrate and not to limit the disclosure. The features of some embodiments of the present disclosure, which are believed to be novel, will be more fully disclosed in the following detailed description. The following detailed description may best be understood by reference to the accompanying drawings wherein the same numbers in different drawings represents the same parts. All drawings are schematic and are not intended to show any dimension to scale. The drawings comprise the following figures in which:

FIG. 1A is a front view of an embodiment of a pulsation dampener.

FIG. 1B is a side view of the pulsation dampener of FIG. 1A.

FIG. 1C is a cross-sectional view of the pulsation dampener of FIG. 1A, with a linkage assembly shown in an intermediate configuration.

FIG. 1D is a cross-sectional view of the pulsation dampener of FIG. 1A, with the linkage assembly shown in an extended configuration.

FIG. 1E is a cross-sectional view of the pulsation dampener of FIG. 1A, with the linkage assembly shown in a retracted configuration.

FIG. 1F is an enlarged cross-section view of a portion of the pulsation dampener of FIG. 1A.

FIG. 2 is a schematic diagram of an embodiment of a fluid piping system that comprises the pulsation dampener of FIG. 1A.

FIG. 3A is a cross-sectional view of another embodiment of a pulsation dampener, with a linkage assembly shown in an intermediate configuration.

FIG. 3B is a cross-sectional view of the pulsation dampener of FIG. 3A, with the linkage assembly shown in an extended configuration.

FIG. 3C is a cross-sectional view of the pulsation dampener of FIG. 3A, with the linkage assembly shown in a retracted configuration.

FIG. 3D is an enlarged cross-section view of a portion of the pulsation dampener of FIG. 3A.

FIG. 4 is a block diagram of another embodiment of a pulsation dampener.

FIG. 5A is a perspective view of another embodiment of a pulsation dampener.

FIG. 5B is a partial exploded view of the pulsation dampener of FIG. 5A.

FIG. 6 is a schematic diagram of an embodiment of a fluid piping system that comprises the pulsation dampener of FIG. 5A.

FIG. 7A is a side view of a spring actuator assembly of the pulsation dampener of FIG. 5A.

FIG. 7B is a partial exploded view of the spring actuator assembly of FIG. 7A.

FIG. 7C is a cross-sectional view of the spring actuator assembly of FIG. 7A, shown in an extended configuration.

FIG. 7D is a cross-sectional view of the spring actuator assembly of FIG. 7A, shown in a compressed or retracted configuration.

FIG. 8A is a partial perspective view of the pulsation dampener of FIG. with the spring actuator assembly shown in an extended configuration.

FIG. 8B is a partial perspective view of the pulsation dampener of FIG. with the spring actuator assembly shown in a compressed or retracted configuration.

FIG. 8C is a partial perspective view of the pulsation dampener of FIG. with the spring actuator assembly shown in an intermediate configuration.

FIG. 9 is a side view of a portion of the spring actuator assembly of the pulsation dampener of FIG. 5A.

FIG. 10A is a side view of a first link of a linkage assembly of the spring actuator assembly of FIG. 7A.

FIG. 10B is a side view of a second link of the linkage assembly of the spring actuator assembly of FIG. 7A.

FIG. 10C is a side view of a third link of the linkage assembly of the spring actuator assembly of FIG. 7A.

FIGS. 11A-11C illustrate example embodiments of mechanical advantage graphs.

FIG. 12A is a perspective view of another embodiment of a pulsation dampener.

FIG. 12B is an exploded view of the pulsation dampener of FIG. 12A.

FIG. 12C is an enlarged view of a portion of the exploded view of FIG. 12B.

FIGS. 12D and 12E are cross-sectional views of the pulsation dampener of FIG. 12A.

FIG. 13A is a perspective view of the pulsation dampener of FIG. 12A, with a spring actuator assembly shown in a compressed or retracted configuration.

FIG. 13B is a perspective view of the pulsation dampener of FIG. 12A, with the spring actuator assembly shown in an intermediate configuration.

FIG. 13C is a perspective view of the pulsation dampener of FIG. 12A, with the spring actuator assembly shown in an extended configuration.

FIGS. 14A and 14B are side views of the spring actuator assembly of the pulsation dampener of FIG. 12A.

FIG. 15A is a side view of a portion of the spring actuator assembly of the pulsation dampener of FIG. 12A.

FIG. 15B is another side view of a portion of the spring actuator assembly of the pulsation dampener of FIG. 12A.

### DETAILED DESCRIPTION

Although several embodiments, examples, and illustrations are disclosed below, it will be understood by those of ordinary skill in the art that the inventions described herein extend beyond the specifically disclosed embodiments, examples, and illustrations and include other uses of the inventions and obvious modifications and equivalents thereof. Embodiments of the inventions are described with reference to the accompanying figures, wherein like numerals refer to like elements throughout. These drawings are considered to be a part of the entire description of some embodiments of the inventions. The terminology used in the description presented herein is not intended to be interpreted in any limited or restrictive manner simply because it is being used in conjunction with a detailed description of certain specific embodiments of the inventions. In addition, embodiments of the inventions can comprise several novel features and no single feature is solely responsible for its desirable attributes or is essential to practicing the inventions herein described.

Fluid piping systems are used in various industries to transfer liquid such as water, gas, oil, chemicals, and/or the like. A pump is often used to transfer such fluid from an upstream portion of the piping system to a downstream portion. Positive displacement pumps, such as piston pumps, diaphragm pumps, peristaltic pumps, and others, tend to put out a pulsing flow. The pulses in the flow can cause problems in the system, and often a smoother flow is desirable.

One way to smooth out a fluid flow is to use a fluid pulsation dampener that includes a gas chamber that contains a pressurized gas. The fluid pulsation dampener may also include a bladder or other deformable member that is in fluid communication with the pressurized gas on one side and with the fluid flow on the other side. Pulsations in the fluid flow may be absorbed by deforming the bladder and thus compressing the gas within the gas chamber. Such pulsation dampeners can be effective, but also come with a variety of problems. For example, with a gas charged dampener, the primary way to increase dampening performance is to have more volume of gas, which makes the dampener larger and more expensive. As another example, with a gas charged dampener, the pressure within the gas chamber should be checked often to make sure that the gas within the chamber has not leaked out, thus changing the performance of the gas charge dampener. Further, when the gas does leak out (or if adjustment is otherwise needed), a source of compressed gas needs to be available to charge the dampener. Additionally, it can be difficult to tell if a gas charged dampener is charged correctly (e.g., if the pressure within the gas chamber is appropriate for the particular application).

The present disclosure describes various embodiments of fluid pulsation dampeners that utilize one or more mechanical springs instead of a gas charge to dampen pressure pulses and flow fluctuations in a piping system. For example, some embodiments utilize a deformable member, such as a diaphragm, bellows, and/or the like, with the deformable member comprising a wetted side in contact with a fluid flow and a non-wetted side that applies force to, and receives force from, one or more mechanical springs. One problem with using a spring directly, however, is that in order to get smoother flow and minimize pressure pulses, the spring desirably should compress with only a small increase in force on the deformable member. In other words, the spring rate of the mechanical spring should desirably be relatively small. Springs with small spring rates tend to be relatively long, however. Using such a spring in a fluid pulsation dampener can make the design impractical, because the dampener may be too large and/or expensive.

Various embodiments disclosed herein solve this problem by utilizing links, linkages, levers, and/or the like that modify or control how the mechanical spring force is applied to the deformable member, such as by providing a mechanical advantage between the spring and the deformable member. For example, for a relatively small pulsation dampener, it can be practical to use a relatively strong or higher force spring configured to move only a relatively small distance, with one or more linkages that cause the diaphragm or other deformable member to move a relatively larger distance. Stated another way, the one or more linkages can generate a mechanical advantage that amplifies a force transferred between the spring and the deformable member. The desired dampening performance of such a fluid pulsation dampener can be controlled by, among other things, the magnitude of mechanical advantage provided by the linkages, the spring rate of the mechanical spring, the amount of preload force on the spring, the surface area of the portion of the deformable member that is acted on by the fluid, and/or the like.

In some embodiments that utilize linkages, levers, and/or the like to generate a mechanical advantage between the spring and the deformable member, there can be a trade-off between how effectively pulses can be dampened and over what range of pressures the dampener is effective for. For example, a dampener that creates a very smooth flow with very small pressure pulses can be designed with less mechanical advantage on the spring, but may tend to have a more narrow range of pressures that it operates at without needing adjustment. A dampener that will operate within a larger range of pressures, without the need of adjustment, could have more mechanical advantage, but will tend to result in larger pressure pulses. There can also be a trade-off between the volume of the fluid chamber that is in contact with the deformable member and the effective pressure range of the dampener. For example, a larger volume of the fluid chamber will generally lead to a larger effective pressure range of the dampener.

Various designs disclosed herein that utilize one or more mechanical springs combined with one or more leverage mechanisms can have a number of advantages over fluid pulsation dampeners that utilize a gas charged chamber. For example, it can be possible to adjust to the dampening performance of a dampener without necessarily making the dampener bigger. Various factors can be adjusted, including the magnitude of mechanical advantage between the spring and the deformable member, whether the mechanical advantage is greater than one or less than one, whether the mechanical advantage is linear or nonlinear throughout the stroke of the deformable member and/or spring, and/or the like. Such factors can be adjusted without necessarily changing the size of the dampener. With a gas charged dampener, on the other hand, the primary way to increase dampening performance is to have a larger volume of gas in the gas charged chamber, making the dampener larger and more expensive.

Another advantage of various designs disclosed herein is that it can be easier to adjust the dampeners, and the dampeners will tend to stay at the set adjustment over time. For example, some embodiments may be adjustable by merely using a screwdriver or wrench to adjust the preload on the spring, and the adjusting screw will tend to stay in place over time. With a gas charged dampener, on the other hand, a source of pressurized gas must be used to charge the gas chamber, and gas within the gas chamber will often tend to leak out over time, requiring regular checks of the gas charged dampener to see if adjustments are needed.

Another advantage of various designs disclosed herein is that it may be easier to tell if the pulsation dampener is adjusted correctly. For example, some designs disclosed herein include an opening, window, or other feature that allows one to view the position of one or more internal components, such as one or more components of the leverage or linkage mechanism between the spring(s) and the deformable member(s). If the dampener is adjusted correctly for the current operating conditions, one or more of such internal components may be visible in a specific location through the opening or window.

### Pulsation Dampening in Fluid Piping Systems

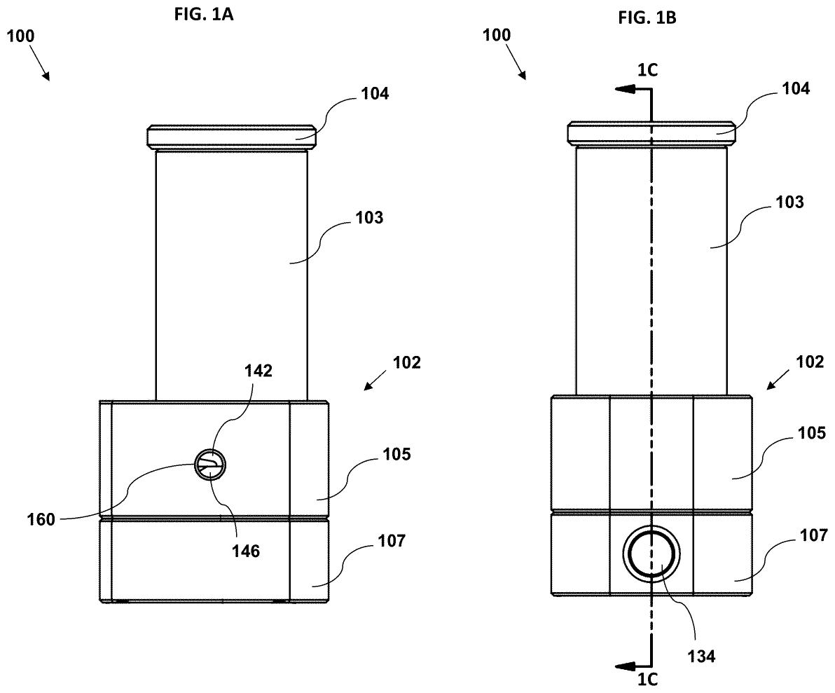

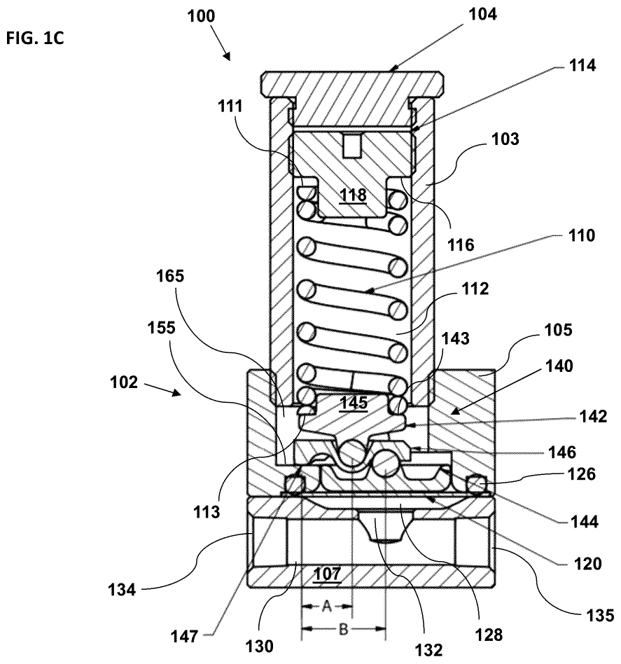

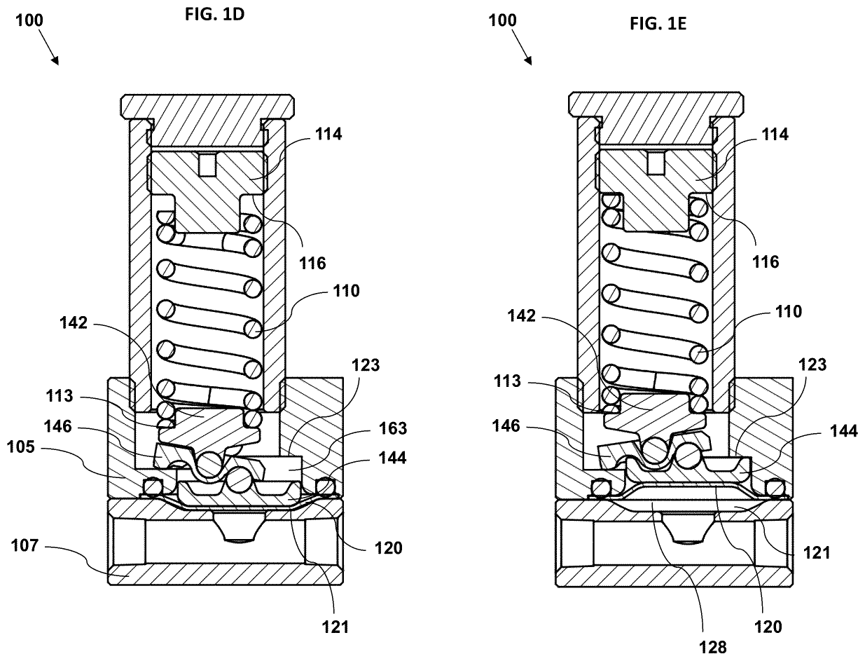

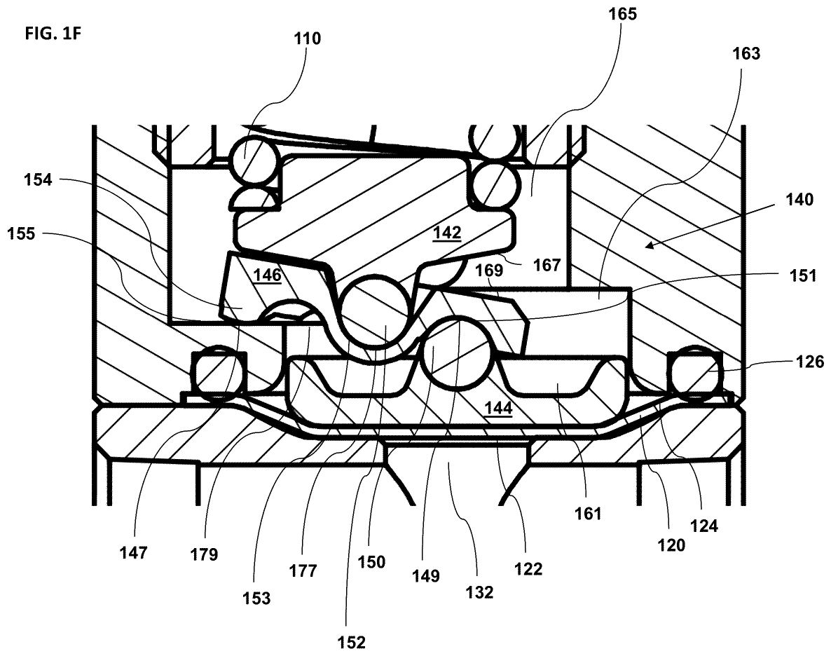

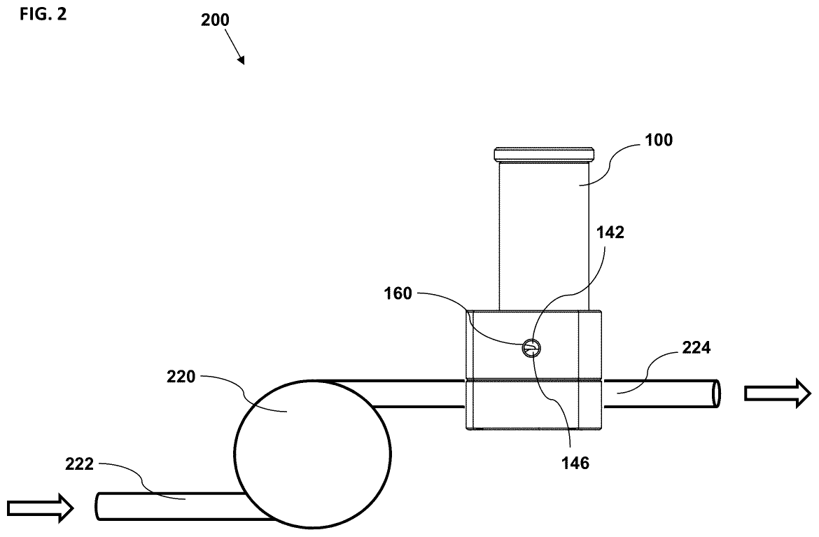

Turning to the figures, FIGS. 1A-1C illustrate one embodiment of a fluid pulsation dampener 100. FIG. 1A illustrates a front view of the pulsation dampener 100, FIG. 1B illustrates a side view, and FIG. 1C illustrates a cross-sectional view. FIG. 2 illustrates a schematic diagram of the pulsation dampener 100 in use in a fluid piping system 200. The schematic diagram of FIG. 2 is not shown to scale. The fluid piping system 200 comprises a pump 220 that is in fluid communication with upstream piping 222 and downstream piping 224. The pulsation dampener 100 is connected in fluid communication with the downstream piping 224, in a flow-through arrangement, in order to reduce and/or eliminate pulsations, vibrations, and/or the like in the fluid flow output from the pump 220. The pulsation dampener 100 may be used in fluid piping systems having various types of pumps 220, such as positive displacement, piston, diaphragm, peristaltic, centrifugal, metering, hose, air operated double diaphragm pumps, and/or the like.

The pulsation dampener 100 of FIG. 1C includes a housing 102 that defines an internal cavity 112 having a spring 110 positioned therein. The spring 110 is connected to a linkage assembly 140, which is in turn connected to a deformable member 120 (in this case a diaphragm 120). Movement of the diaphragm 120 defines a volume of a fluid chamber 128 that is in fluid communication with the fluid flow through piping 224 of FIG. 2.

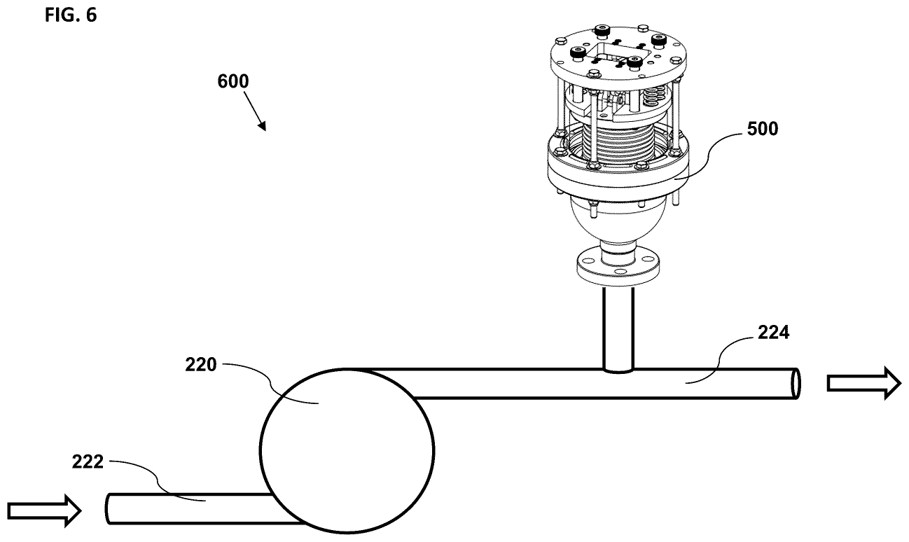

In the fluid piping system 200 of FIG. 2, the pulsation dampener 100 is connected in a flow-through configuration, meaning that fluid flow from the downstream piping 224 enters the pulsation dampener 100 via one port (such as port 134 of FIG. 1C), and exits the pulsation dampener 100 via a second port (such as port 135 of FIG. 1C). The concepts disclosed herein are not limited to such arrangements, however, and could be used with a pulsation dampener configured in an appendage configuration (meaning that the pulsation dampener is connected in parallel with the output of the pump, using a single liquid inlet/outlet port through which fluid can enter and exit the fluid chamber of the pulsation dampener). For example, the pulsation dampener 500 of FIG. 6, discussed below, is arranged in such an appendage configuration.

### Example Fluid Pulsation Dampener

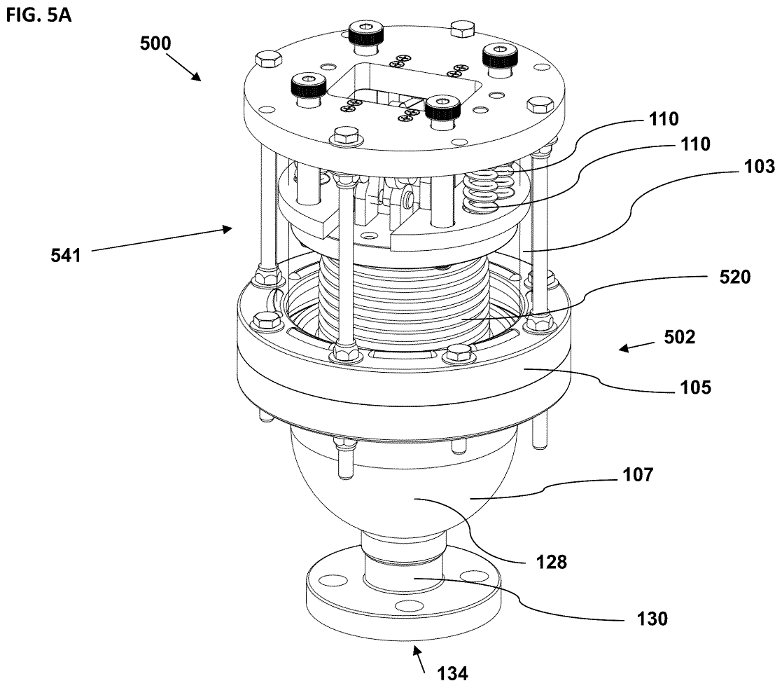

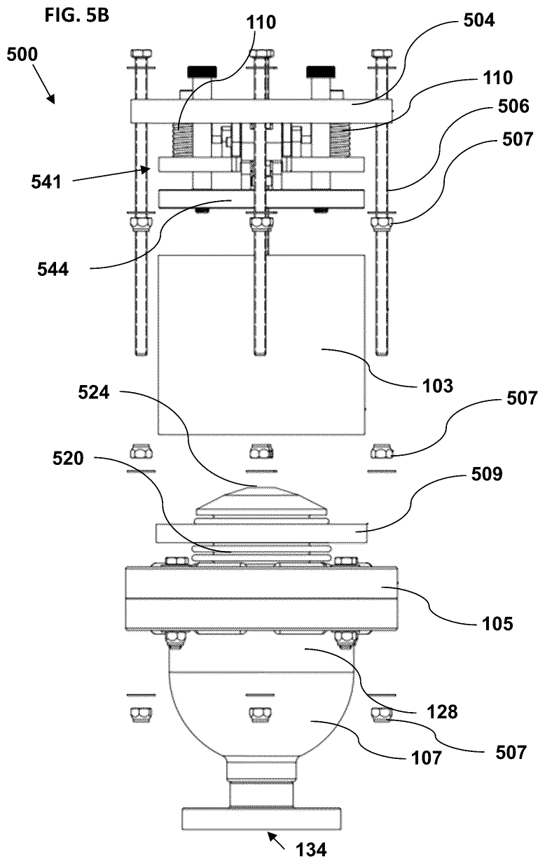

Returning to FIGS. 1A-1C, the fluid pulsation dampener 100 comprises a housing 102 that, in this embodiment, comprises an upper portion or first portion 103, a middle portion or second portion 105, and a lower portion or third portion 107. Other embodiments may form the housing from more or fewer portions. The dampener 100 further comprises a cap 104 coupled to an upper end of the upper portion 103. With reference to FIG. 1A, the middle portion 105 of the housing 102 desirably comprises a sight window or hole 160 that enables a user of the dampener to see certain portions of the internal components of the dampener. For example, in this case, a spring pivot 142 and mechanical advantage linkage 146 (discussed below) are visible within the sight hole 160. This can be beneficial, because it can allow a user to quickly see whether the linkage assembly 140 (see FIG. 1C) is in a proper orientation, and thus the pulsation dampener is adjusted correctly for the current application. FIG. 1B further illustrates a first fluid port 134, and a second fluid port 135 can be seen in FIG. 1C. In this embodiment, either of the fluid ports 134 or 135 may act as the fluid inlet or outlet. In some embodiments, however, it may be desirable for one of the fluid ports to act as the inlet and the other to act as the outlet. Further, in some embodiments, a single fluid port may act as both the fluid inlet and outlet (see, for example, the fluid pulsation dampener 500 of FIG. 5A, discussed below).

With reference to the cross-sectional view of FIG. 1C, the upper and middle portions 103, 105 of the housing 102 define cavities 112, 165, respectively, within which a spring 110 and/or a spring seat or pivot 142 is positioned. In this embodiment, the spring 110 is a single compression spring that provides a compression force between face 116 of the spring force adjustment screw 114 and face 143 of the spring pivot or spring seat 142 of the linkage assembly 140. More specifically, a first end 111 of the spring 110 desirably presses against face 116 of the spring force adjustment screw 114, and a second end 113 of the spring 110 desirably presses against face 143 of the spring pivot or spring seat 142. The spring 110 is desirably maintained in position in a relatively centered position with respect to the interior surface of upper portion 103 of the housing 102 by a protrusion 118 extending downward from a center of the spring force adjustment screw 114, and by a protrusion 145 that extends upward from a central portion of the spring pivot 142.

The spring force adjustment screw 114 desirably comprises an external thread that engages an internal thread on the interior of upper portion 103 of the housing 102, enabling the spring force adjustment screw 114 to be rotated (such as using a screwdriver, wrench, and/or the like), thus causing the screw 114 to translate axially along a central longitudinal axis of the upper portion of the housing 103 and/or of the spring 110, which will set a preload of the spring 110. The cap or dust cap 104 desirably also threads into the upper portion 103 of the housing 102 in order to keep dust or other contaminants out of the housing 102. In some embodiments, one or more seals, such as gaskets, 0-rings, and/or the like may be positioned between the dust cap 104 and the upper portion 103 of the housing 102.

With continued reference to FIG. 1C, the lower portion 107 of the housing 102 is desirably coupled to a lower side of the middle portion 105 of the housing 102, with an outer radial edge of the diaphragm 120 captured therebetween. Further, a seal or 0-ring 126 may help to seal the diaphragm 120 to the housing 102. The lower portion of the housing 107 comprises the fluid ports 134 and 135 that each act as a fluid inlet or outlet, depending on how the fluid pulsation dampener 100 is positioned within the fluid piping system. The fluid ports 135 and 134 are fluidly coupled by a fluid flow channel 130 that passes through the lower portion 107 of the housing 102. The lower portion 107 of the housing 102 further comprises a fluid port 132 that fluidly couples the fluid flow channel 130 to a fluid chamber 128. The fluid chamber 128 is desirably a variable volume fluid chamber that is at least partially defined by the position of the diaphragm 120.

In operation, a fluid flow from a fluid piping system will flow through the fluid flow channel 130 and be in fluid communication with the fluid chamber 128. Pressure pulsations in the fluid flow will tend to increase the pressure in fluid chamber 128 and thus increase the volume of fluid chamber 128 by deforming a portion of the diaphragm 120 upward. Such upward movement of the diaphragm 120 is resisted by the compression force from the spring 110, as modified through linkage assembly 140. The linkage assembly 140 desirably comprises a first member, such as spring seat or pivot 142, that is coupled to the second end 113 of the spring 110, a second member, such as diaphragm seat 144, that is coupled to the upper or nonwetted side of the diaphragm 120, and a third member, such as mechanical advantage linkage, link, or lever 146, that is positioned in pivotal contact with each of the spring pivot 142, the diaphragm seat 144, and the housing 102 (and more specifically, a face 155 of middle housing portion 105, at pivot point 147).

The linkage assembly 140 is configured to generate a mechanical advantage between the spring 110 and the diaphragm 120. In this design, the mechanical advantage is calculated as a ratio of length A divided by length B. Length A is the distance between pivot point 147 and the pivot point between spring pivot 142 and the mechanical advantage linkage 146 (see pivot point 177 of FIG. 1F). Length B is the distance between pivot point 147 and the pivot point between diaphragm seat 144 and the mechanical advantage linkage 146 (see pivot point 149 of FIG. 1F). The distances A and B are measured along the horizontal direction (with reference to the orientation of FIG. 1C) and/or are measured perpendicular to the longitudinal axis of the spring 110, the diaphragm seat 144, and/or the diaphragm 120. Further details of the structures of these components are described below with reference to the enlarged cross-sectional view of FIG. 1F.

In the embodiment shown in FIG. 1C, length A is less than length B, and thus the mechanical advantage in this design is desirably less than one. In such a design, the force generated by the spring 110 is desirably higher than the force acting on the diaphragm seat 144. This also means that, as the spring seat 142 and diaphragm seat 144 move, the second end 113 of the spring 110 will move up or down a shorter distance than the portion of the diaphragm 120 that is connected to the diaphragm seat 144. Stated another way, the linkage assembly 140 provides a mechanical advantage that amplifies the forces applied by the diaphragm 120 to the linkage assembly 140, and that attenuates the forces applied by the spring 110 to the linkage assembly 140. Other embodiments may have a mechanical advantage greater than one, which would amplify the forces applied by the spring 110 to the linkage assembly 140, and attenuate the forces applied by the diaphragm 120 to the linkage assembly 140.

With continued reference to the fluid pulsation dampener 100 shown in FIG. 1C, this embodiment illustrates a design where the mechanical advantage (length A divided by length B) is approximately 0.6. This design is also a relatively small design, with the middle and lower portions 105, 107 of the housing 102 being approximately 2 inches in outer diameter. Such a design can be effective to, for example, absorb pressure pulses of approximately 5 psi or less. Various adjustments or modifications may be made in order to most effectively absorb pressure pulses that are larger or smaller, that occur over a wider or lower range of pressures, and/or the like. For example, length A may be made smaller with respect to length B (leading to a smaller mechanical advantage, such as approximately 0.5, 0.4, or 0.3), or length A may be made bigger with respect to length B (leading to a larger mechanical advantage, such as approximately 0.7, 0.8, 0.9, 1.1, 1.2, 1.3, 1.4, or 1.5). Further, the overall size of the dampener 100 may be made bigger or smaller. In some embodiments, the linkage assembly of the pulsation dampener 100 is configured to provide a mechanical advantage that is within a range of 0.5-0.7, 0.4-0.8, 0.55-0.65, 0.4-0.9, and/or the like.

It should be noted that, with the design shown in FIG. 1C, which includes a single link, linkage, or lever 146 between the spring pivot 142 and diaphragm seat 144, the amount of mechanical advantage may vary somewhat throughout the stroke of the diaphragm 120 (e.g., from the fully down or extended position shown in FIG. 1D to the fully up or retracted position shown in FIG. 1E), but the amount of variance may be relatively small and may be relatively linear throughout the stroke. In some embodiments, it may be desirable however to have a larger change in mechanical advantage throughout the stroke, a nonlinear change in mechanical advantage throughout the stroke, and/or the like. An example of such a design is described below with reference to the fluid pulsation dampener 500 of FIG. 5A.

Turning to FIGS. 1D and 1E, these figures illustrate the extents of the strokes of the diaphragm 120 and spring 110. Specifically, FIG. 1D illustrates the diaphragm seat 144 and spring seat 142 in their lowest position (e.g., the fully down or extended configuration of linkage assembly 140), and FIG. 1E illustrates the diaphragm seat 144 and spring seat 142 in their highest position (e.g., the fully up or retracted configuration of linkage assembly 140). FIG. 1C, on the other hand, illustrates the diaphragm seat 144 and spring seat 142 in a middle position (e.g., an intermediate configuration of linkage assembly 140). It should be noted that, in each of FIGS. 1C, 1D, and 1E, the spring 110 is shown in its compressed configuration (e.g., the configuration the spring would be in with the diaphragm 120 in the fully upward position, as shown in FIG. 1E). This causes the upper or first end 111 of the spring 110 to be shown spaced apart from face or surface 116 of the spring force adjustment screw 114 in FIGS. 1C and 1D. In reality, however, the spring 110 will expand to take up the space between face 116 of the spring force adjustment screw 114 and face 143 of the spring pivot 142 in each of the diaphragm orientations shown in FIGS. 1C, 1D, and 1E.

The lowest position, shown in FIG. 1D, is the position that the diaphragm seat 144 and thus the diaphragm 120 will tend to be in when there is no pressure within fluid chamber 128 (such as before the fluid pulsation dampener 100 is put into service). The highest position, shown in FIG. 1E, is the position that the diaphragm seat 144 and thus the diaphragm 120 will tend to be in when the fluid pressure within fluid cavity or chamber 128 is at a relatively high level (e.g., potentially at a level that is higher than the pulsation dampener 100 is presently intended to operate at). Desirably, the spring force adjustment screw 114 will be adjusted such that, during normal operation, the diaphragm seat 144 will fluctuate up and down around the middle, central, or intermediate position shown in FIG. 1C, without reaching the fully down position of FIG. 1D or the fully up position of FIG. 1E. One way for a user of the system to confirm that the spring force adjustment screw 114 is adjusted correctly is for the user to put the fluid pulsation dampener 100 into operation and look through the sight window or hole 160 shown in FIG. 1A. If the mechanical advantage linkage 146 stays in approximately the center of the sight window 160 (or fluctuates somewhat up-and-down around that position), the user will know that the pulsation dampener is adjusted correctly.

With continued reference to FIGS. 1D and 1E, these figures also show how the mechanical limits of movement of diaphragm seat 144 (and/or other components of linkage assembly 140) are constrained. For example, the middle portion 105 of the housing comprises a cavity 163 within which the diaphragm seat 144 moves up and down. Desirably, the outer shape of the diaphragm seat 144 is circular, and the cavity 163 is also circular in shape, but of a slightly larger diameter. A surface 123 at the top of the cavity 163 desirably defines the upper limit of the movement of the diaphragm seat 144. For example, as can be seen in FIG. 1E, the diaphragm seat 144 is in contact with the surface 123. Additionally, a surface 121 defined by the lower portion 107 of the housing desirably defines the lower limit of movement of the diaphragm seat 144. For example, it can be seen in FIG. 1D that the diaphragm 120 is forced against surface 121, thus stopping further downward movement of the diaphragm 120 and diaphragm seat 144.

Turning to FIG. 1F, FIG. 1F is an enlarged view of a portion of the cross-sectional view of FIG. 1D, which shows the diaphragm seat 144 and spring seat 142 in their fully extended or furthest downward positions (e.g., corresponding to the fully extended configuration of the linkage assembly 140). This figure illustrates further details of the linkage assembly 140 and its various components. For example, the diaphragm seat 144 desirably comprises a circular outer shape that is configured to slide up and down within cavity 163. The diaphragm seat 144 further comprises a pivot portion 150 extending upward from a center thereof, although other embodiments may position the pivot portion 150 differently. In this embodiment, the pivot portion 150 comprises a ball, rod, and/or the like that comprises a convex shape configured to pivotally engage pivot portion or annular recess 151 of the linkage 146, which comprises a complementary concave shape. In some embodiments, the pivot portion 150 and pivot portion 151 may slidably engage one another, and in some embodiments one or more bearings may be used such that the surfaces of pivot portions 150 and 151 do not need to slide against one another. Finally, the diaphragm seat 144 desirably comprises an annular recess 161 that is configured to provide clearance for certain portions of the mechanical advantage linkage 146 when the diaphragm seat 144 is in the upper and lower or extended in retracted configurations.

The mechanical advantage linkage 146 further comprises a pivot portion 154 that desirably comprises a convex surface configured to pivot against face 155. As discussed above, the horizontal distance (e.g., measured perpendicular to a longitudinal axis of the diaphragm 120 and/or spring 110) between pivot point 147 (the pivot point between face 155 and pivot portion 154) and pivot point 149 (the pivot point between pivot portion 150 and pivot portion 151) defines dimension B shown in FIG. 1C, which forms part of the mechanical advantage calculation.

The mechanical advantage linkage 146 further comprises a pivot portion 153 that is engaged with pivot portion 152 of the spring seat 142 in order to allow the mechanical advantage linkage 146 to also pivot with respect to the spring seat 142. Similar to the pivot portion 150 of the diaphragm seat 144, the pivot portion 152 of the spring seat 142 may comprise a ball, rod, and/or the like that comprises, for example, a convex surface that mates with a complementary concave surface of pivot portion 153 of the mechanical advantage linkage 146. In some embodiments, pivot portion 152 is slidably engaged with pivot portion 153, while in some embodiments one or more bearings may be used such that the surfaces of pivot portion 152 and 153 do not need to slide against each other. In this embodiment, pivot portions 152 and 153 are generally centrally arranged in the spring seat 142 and mechanical advantage linkage 146, respectively, but centrally arranging such features is not a requirement. For example, it may be desirable to adjust dimension A of FIG. 1C to adjust the amount of mechanical advantage generated by the linkage assembly 140. Dimension A of FIG. 1C is desirably determined by the horizontal measurement (e.g., measured perpendicular to a longitudinal axis of the spring 110 and/or diaphragm 120) between pivot point 147 and pivot point 177, which is the pivot point between pivot portions 152 and 153.

With continued reference to FIG. 1F, the pivot portion or annular recess 151 of the mechanical advantage linkage 146 desirably fulfils multiple purposes. For example, a portion of the annular recess 151 is configured to pivot with respect to pivot portion 150 of the diaphragm seat 144, and another portion of the annular recess 151 is configured to provide clearance for edge 179 of the housing, such as when mechanical advantage linkage 146 is in the downward orientation shown in FIG. 1F.

With continued reference to FIG. 1F, the mechanical advantage linkage 146 and spring seat 142 are also desirably configured to have clearance from one another in order to allow the mechanical advantage linkage 146 to move between the fully down and fully up positions. For example, the mechanical advantage linkage 146 comprises an upper surface or face 169 and the spring seat 142 comprises a lower face or surface 167. Desirably, the lower face or surface 167 of the spring seat 142 is oriented at an angle such that the upper face or surface 169 of the mechanical advantage linkage 146 does not contact the spring seat 142 in the raised and lowered configurations. In some embodiments, the face 167 is positioned such that it does contact upper face or surface 169 of the mechanical advantage linkage 146, to help to provide a mechanical limit to the rotation of the mechanical advantage linkage 146 in the upper and/or lower positions.

FIG. 1F further shows that the deformable member or diaphragm 120 comprises a first side 122 and a second side 124. The first side 122 is desirably in fluid communication with fluid in the pumping system through fluid port 132 and fluid chamber 128 (see FIG. 1C). In some cases, the first side 122 is referred to as the wetted side. The second side 124 of the diaphragm 120 may be referred to as the dry or nonwetted side. In this embodiment, the second side 124 of the diaphragm 120 is engaged with a lower surface of the diaphragm seat 144. In the lower or extended position shown in FIG. 1F, the downward movement of the diaphragm seat 144 may be limited at least partially by the diaphragm seat 144 compressing the diaphragm 120 between the lower surface of the diaphragm seat 144 and surface 121 (see FIG. 1E).

FIG. 1F further shows that the spring seat 142 is positioned substantially within a cavity 165. Desirably, the cavity 165 is of a size and configuration that allows the spring seat 142 and mechanical advantage linkage 146 to move without interference from the housing 102.

### Additional Example Fluid Pulsation Dampener Embodiment

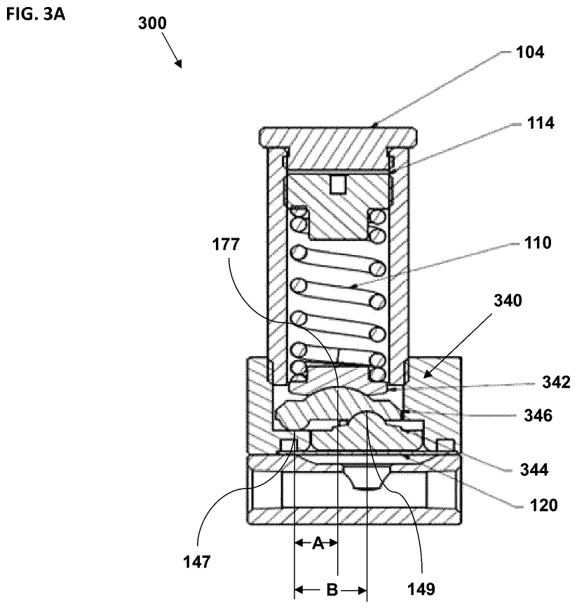

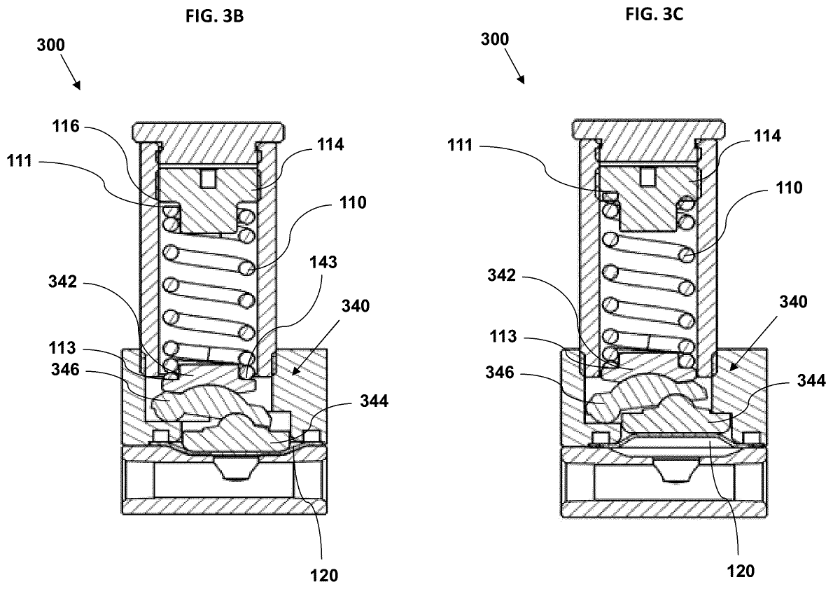

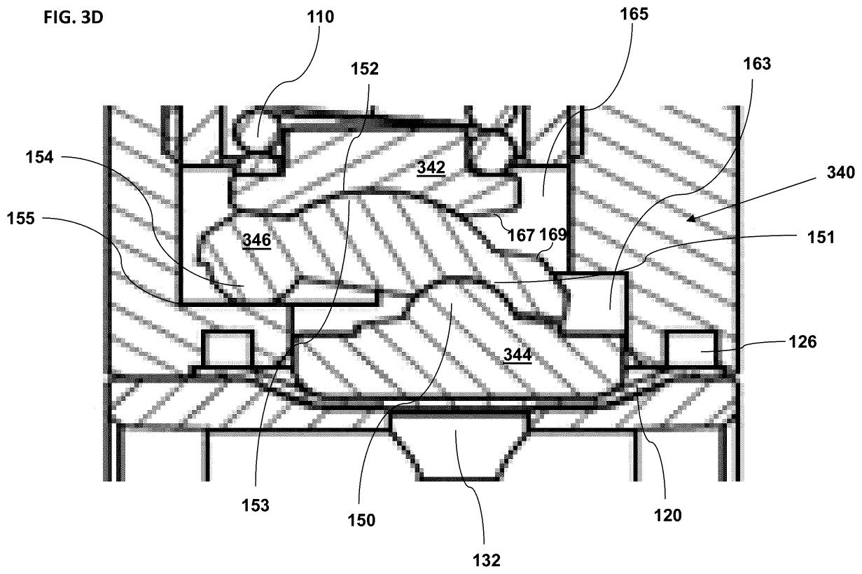

FIGS. 3A-3D illustrate another embodiment of a fluid pulsation dampener 300 that utilizes a mechanical spring 100 and a linkage assembly 340 instead of a pressurized gas charge to absorb pulsations. The fluid pulsation dampener 300 is similar to the fluid pulsation dampener 100 described above with reference to FIGS. 1A-1F, and the same or similar reference numbers are used to refer to the same or similar components. For efficiency, the below description focuses on differences in the fluid pulsation dampener 300 as compared to the fluid pulsation dampener 100.

FIGS. 3A, 3B, and 3C illustrate cross-sectional views similar to cross-sectional views 1C, 1D, and 1E, respectively. Specifically, FIG. 3A illustrates the linkage assembly 340 in a middle or intermediate configuration, FIG. 3B illustrates the linkage assembly 340 in a fully extended or down configuration, and FIG. 3C illustrates the linkage assembly 340 in a fully retracted or up configuration. Stated another way, in the configuration of FIG. 3B, the diaphragm seat 344 and spring seat 342 are in their lowest or most extended position, while in FIG. 3C, the diaphragm seat 344 and spring seat 342 are in their uppermost or most retracted position.

Similar to FIGS. 1C, 1D, and 1E, the spring 110 of FIGS. 3A-3C is shown in the same configuration and all three figures. Specifically, in this embodiment, the spring 110 is shown at approximately the intermediate or middle position, as the spring 110 would be in in the configuration of FIG. 3A. Accordingly, in the extended configuration of FIG. 3B, there is shown some space between the upper end 111 of the spring 110 and the face 116 of the spring adjustment screw 114, and in the retracted configuration of FIG. 3C, the upper end 111 of the spring 110 is shown interfering with the spring adjustment screw 114. In reality, the spring 110 would extend or retract to fill the distance between the face 116 of the adjustment screw 114 and face 143 of the spring seat 342.

FIG. 3D is an enlarged portion of the cross-sectional view of FIG. 3B, similar to the enlarged view of FIG. 1F discussed above. FIG. 3D shows additional details of how the linkage assembly 340 of pulsation dampener 300 differs from linkage assembly 140 of pulsation dampener 100 discussed above. For example, the spring seat 342 comprises a concave pivot portion 152 that slides against a convex pivot portion 153 of the mechanical advantage linkage 346. This is opposite to the arrangement in linkage assembly 140. Additionally, the linkage assembly 140 shows that pivot portions 150 and 152 may comprise a separate ball, shaft, and/or the like, while linkage assembly 340 of FIG. 3D shows that pivot portions 152, 153, and 150 may be integrally formed with the spring seat 342, mechanical advantage linkage 346, and diaphragm seat 344, respectively.

With reference to FIG. 3A, the mechanical advantage generated by linkage assembly 340, calculated as dimension A divided by dimension B, may be the same or similar as in the fluid pulsation dampener 100 discussed above. Accordingly, any of the values or ranges discussed above with respect to the mechanical advantage of fluid pulsation dampener 100 may also apply to fluid pulsation dampener 300.

### Fluid Pulsation Dampener Block Diagram

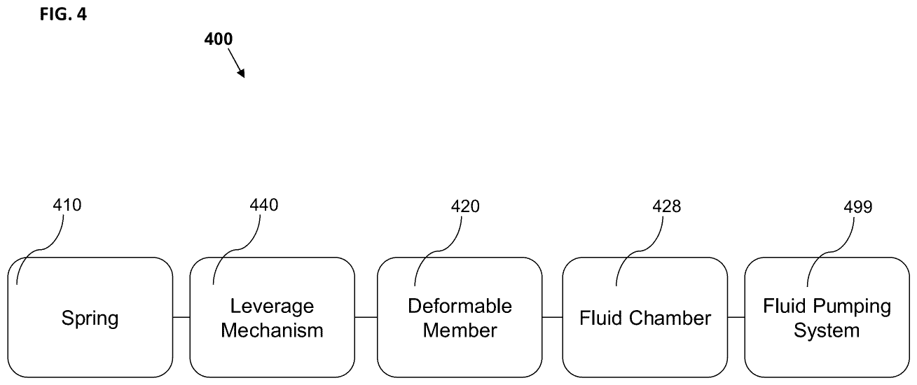

The fluid pulsation dampener concepts disclosed herein may be implemented in a variety of ways, and the concepts disclosed herein are not limited to the specific embodiments shown in the figures. FIG. 4 is a block diagram of a fluid pulsation dampener 400 that may comprise any of the specific mechanical configuration shown in other figures discussed herein, and may also comprise other alternative mechanical configurations. Like other embodiments shown in other figures, however, the fluid pulsation dampener 400 at least includes a leverage mechanism 440 that generates a mechanical advantage between a spring 410 and a deformable member 420. For example, the spring 410 may comprise a mechanical spring, such as an axial spring compression spring, a torsional spring, and/or the like. In some embodiments, the spring 410 may comprise other types of springs, such as a gas spring.

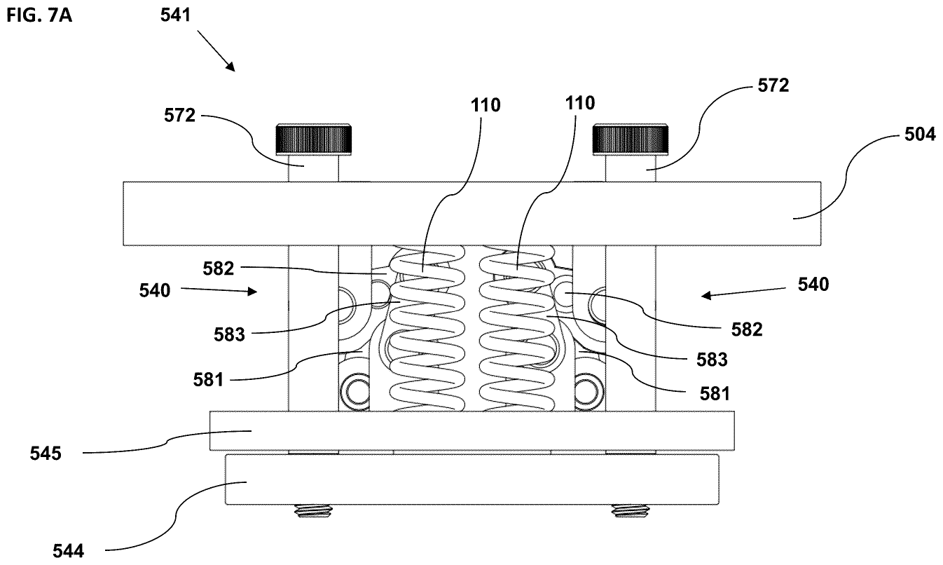

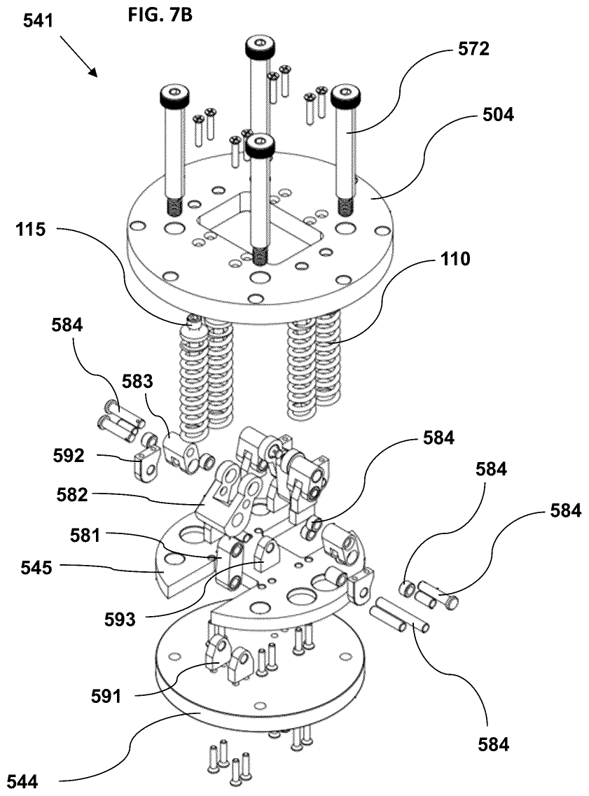

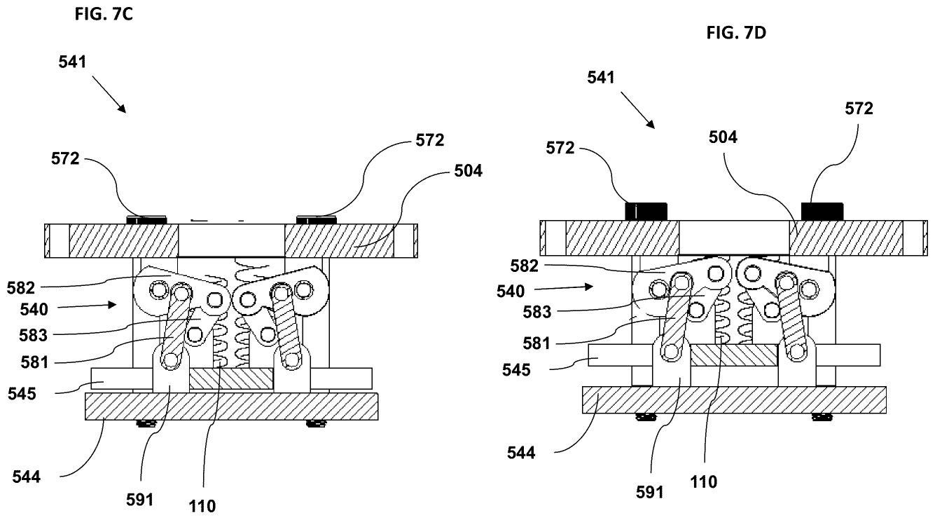

The leverage mechanism 440 may comprise any number of levers, links, linkages, and/or the like that allow for generation of a mechanical advantage between the spring 410 and the deformable member 420. For example, the leverage mechanism 440 may comprise a single lever, link, or linkage, as shown in FIGS. 1F and 3D, or the leverage mechanism 440 may comprise more than one lever, link, or linkage, such as the three links shown in FIG. 7A, discussed below.

The deformable member 420 may comprise various types of deformable members, such as a diaphragm, a bladder, a bellows, and/or the like. The fluid chamber 428 is desirably a fluid chamber that is in fluid communication with a wetted side of the deformable member 420 and also with a fluid pumping system 499, such as through downstream piping 224 of FIG. 2 or 6.

### Additional Example Fluid Pulsation Dampener Embodiment

FIGS. 5A and 5B illustrate another embodiment of a fluid pulsation dampener 500 that incorporates many similar features and functionality as with other pulsation dampeners disclosed herein, but that uses a different type of linkage assembly (e.g., with a greater number of linkages) to transfer force between the deformable member and springs. The different type of linkage assembly used by the fluid pulsation dampener 500 can enable a variety of benefits, such as generating a nonlinear mechanical advantage curve, allowing for more precise adjustments to the mechanical advantage curve, allowing for greater overall stroke of the linkage assembly between fully retracted and fully extended configurations, and/or the like. For example, one benefit of the linkage assembly used with the fluid pulsation dampener 500 is that the nonlinear mechanical advantage curve can enable the springs to provide greater resistance to compression toward the end of their compression stroke, and lesser resistance to compression toward the beginning of their compression stroke, in order to help prevent harsh bottoming out in either direction. In some embodiments, one or more stop members, such as an elastomer or rubber bumper member, may be included and positioned to cushion the bottoming out of the bottom plate 544 and/or the middle plate 545 in one or both directions.

The same or similar reference numbers are used with fluid pulsation dampener 500 as with fluid pulsation dampeners 100 and 300, in order to refer to the same or similar components. For efficiency, the description below focuses on differences in the fluid pulsation dampener 500 from the above-described fluid pulsation dampeners 100 and 300.

FIG. 5A is a perspective view of the fluid pulsation dampener 500, and FIG. 5B is a partially exploded side view of the fluid pulsation dampener 500. With reference to FIG. 5A, the fluid pulsation dampener 500 comprises a housing 502 that includes an upper or first portion 103, a middle or second portion 105, and a lower or third portion 107. The lower portion 107 of the housing 502 desirably comprises a fluid chamber 128 that is in fluid communication with a fluid port 134 through a fluid flow channel 130. In this embodiment, the pulsation dampener 500 comprises a single fluid port 134 that acts as both the inlet and outlet, which is different than pulsation dampener 100 described above, which includes two fluid ports 134, 135.

FIG. 6 is a schematic diagram of a fluid pumping system 600 that illustrates the fluid pulsation dampener 500 in use with the same pump 220, upstream piping 222, and downstream piping 224 as shown in FIG. 2, discussed above. The main difference in FIG. 6 is that the pulsation dampener 500 is connected to downstream piping 224 in an appendage configuration instead of the flow through configuration shown in FIG. 2. As with FIG. 2, FIG. 6 is not shown to scale.

Returning to FIG. 5A, the upper portion 103 of the housing 502 is shown transparent in this figure, in order to show some internal features of the pulsation dampener 500. For example, a portion of a deformable member 520 can be seen. The deformable member 520 in this embodiment desirably comprises a bellows instead of a diaphragm. The bellows 520 desirably comprises an inner or wetted surface that is in fluid communication with the fluid chamber 128. The bellows 520 further comprises an upper end 524 (see FIG. that can desirably translate up and down (e.g. along the longitudinal axis of the bellows 520) in response to pressure surges within the fluid chamber 128. Although not shown in FIG. 5A, the upper portion 103 of the housing 502 may include one or more sight holes or windows, similar to sight hole or window 160 of FIG. 1A, to enable a user to determine whether the pulsation dampener 500 is operating and/or adjusted correctly.

Positioned above the bellows 520 is a spring actuator assembly 541 that comprises a plurality of springs 110 configured to resist the upward movement of the upper end 524 of the bellows 520. With reference to FIG. 5B, the spring actuator assembly 541 comprises a bottom plate 544 that desirably engages the upper end 524 of the bellows 520. In some embodiments, the upper end 524 of the bellows 520 may not directly engage the bottom plate 544. For example, top or plate 509 may be positioned between the upper end 524 of the bellows 520 and the bottom plate 544. The plate 509 may desirably comprise polypropylene, PVC, and/or another material that may help to, for example, reduce wear or damage to the bellows 520. When pressure is increased within the fluid chamber 128, the upper end 524 of the bellows 520 will desirably move upward, thus also moving bottom plate 544 of the spring actuator assembly 541 upward with respect to top plate 504 of the spring actuator assembly 541. As the bottom plate 544 is moved upward with respect to top plate 504, the plurality of springs 110 are compressed (via the plurality of linkage assemblies 540, which are described in more detail below with reference to FIG. 7A), thus providing a resistance to the upward movement of bottom plate 544.

With continued reference to FIG. 5B, the fluid pulsation dampener 500 further comprises a plurality of screws 506 that pass through the top plate 504 of the spring actuator assembly 541, and through the middle portion 105 of the housing 502, in order to retain the spring actuator assembly 541 in place with respect to the rest of the fluid pulsation dampener 500. Some embodiments may include a plurality of fasteners 507, such as nuts and washers, that cooperate with the plurality of screws 506 to retain the various parts of the assembly.

Turning to FIGS. 7A-7D, these figures illustrate additional details of the spring actuator assembly 541 of the fluid pulsation dampener 500 of FIG. 5A. FIG. 7A is a side view of the spring actuator assembly 541 in the fully extended configuration, and FIG. 7B is a perspective, partially exploded view of the spring actuator assembly 541. Additionally, FIGS. 7C and 7D are cross-sectional views of the spring actuator assembly 541, shown in the fully extended configuration (FIG. 7C) and in the fully compressed or retracted configuration (FIG. 7D).

The spring actuator assembly 541 shown in FIGS. 7A-7D comprises a first member, such as a top plate 504, that has a plurality of shoulder bolts 572 (in this case four) passing therethrough and slidably engaged with the top plate 504. The lower threaded ends of the shoulder bolts 572 are coupled with a second member, such as the bottom plate 544, such that movement upward and downward of the bottom plate 544 with respect to the top plate 504 will cause the shoulder bolts 572 to also slide up and down with respect to the top plate 504.

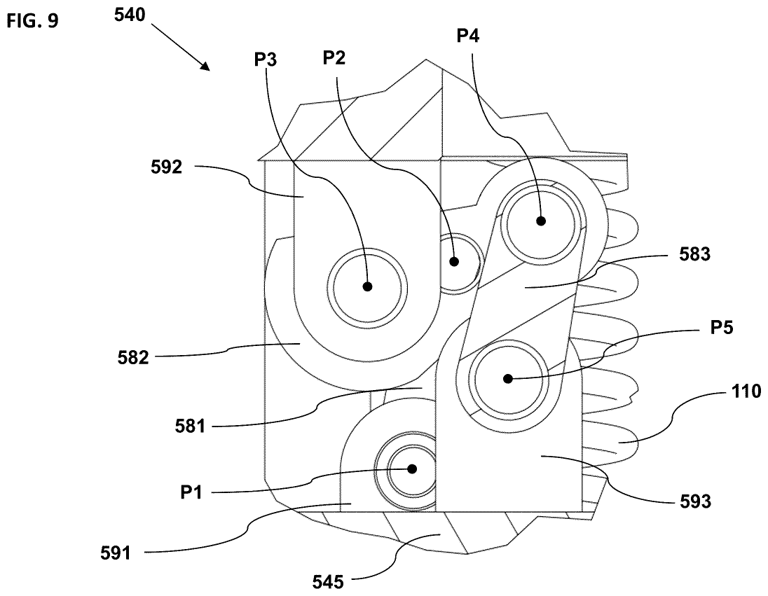

In order to resist upward movement of the bottom plate 544 with respect to the top plate 504, a plurality of springs 110 (in this case four) are positioned between the top plate 504 and bottom plate 544. If the springs 110 directly acted on both the top plate 504 and bottom plate 544, however, there would be no mechanical advantage created between the top plate 504 and bottom plate 544, and the disadvantages of such a design discussed above would apply. In the embodiment illustrated in FIG. 7A, however, the plurality of springs 110 do not act directly on both the top plate 504 and bottom plate 544. In this embodiment, upper ends of the springs 110 are coupled to the top plate 504 (such as via bolts 115), but lower ends of the springs 110 apply force to the bottom plate 544 through a third member, such as middle plate 545, and a plurality of linkage assemblies 540, instead of acting directly on the bottom plate 544. Specifically, the lower ends of the springs 110 are coupled to the middle plate 545, which is slidably coupled to the shoulder bolts 572 and can translate or slide along the axes of the shoulder bolts 572 with respect to both the top plate 504 and the bottom plate 544. The middle plate 545 is further mechanically linked to both the top plate 504 and the bottom plate 544 through a series of links or linkages of two linkage assemblies 540, including first links 581, second links 582, and third links 583. FIG. 9 illustrates more details of one such linkage assembly 540, and will also be referred to while discussing FIGS. 7A-7D. As can be seen in FIG. 7B, the plurality of links 581, 582, and 583 can desirably be pivotally coupled together using a plurality of components 584 that may include, for example, pins, busing, bearings, and/or the like.

It should be noted that, in the embodiment shown in FIG. 7B, the upper ends of the springs 110 are desirably rigidly coupled to the upper plate 504 in a non-adjustable configuration. Some embodiments, however, may incorporate adjustability, similar to the spring force adjustment screw 114 of FIG. 1C, in order to adjust a level of preload on the springs 110. Further, in any of the embodiments disclosed herein, adjustments may be made by swapping the springs 110 with springs having a different spring rate and/or length.

With continued reference to FIGS. 7A-7D, the spring actuator assembly 541 desirably comprises two linkage assemblies 540. Each of the linkage assemblies 540 desirably comprises one first link 581 and one second link 582, with the first link 581 pivotally coupling the bottom plate 544 to the second link 582. More specifically, couplers 591 are rigidly attached to bottom plate 544 and define pivot axis P1 (see FIG. 9) that a first end of first link 581 can pivot about. Further, with reference to FIG. 9, a second end of first link 581 is pivotally coupled at pivot axis P2 to a middle portion of the second link 582.

A first end of the second link 582 of each linkage assembly 540 is desirably pivotally coupled to a pair of couplers 592 at pivot axis P3 (see FIG. 9), with the couplers 592 being rigidly attached to the top plate 504. Next, the opposite end of each of the second links 582 is desirably pivotally coupled at pivot axis P4 (see FIG. 9) with a first end of each of two third links 583. The third links 583 are each in turn desirably pivotally coupled at their other end at pivot axis P5 (see FIG. 9) to a coupler 593 that is rigidly attached to the middle plate 545. The various pivot axes shown in FIG. 9 may take various mechanical forms, such as utilizing bushings, bearings, pins within holes without bushings or bearings, and/or the like.

With continued reference to FIGS. 7A-7D and 9, an upward force on the bottom plate 544 (such as may be applied by the upper end 524 of the bellows 520 shown in FIG. 5B) will cause the first link 581 to press upward on the second link 582 at pivot axis P2. Because pivot axis P3 is rigidly located with respect to the top plate 504, this force will cause pivot axis P4 at the other end of the second link 582 to move upward. The movement of pivot axis P4 upward will in turn cause third link 583 and pivot axis P5 to be pulled upward. This will in turn cause the middle plate 545 to move upward, thus compressing the springs 110 between the middle plate 545 and the top plate 504, and resisting upward movement of the bottom plate 544.

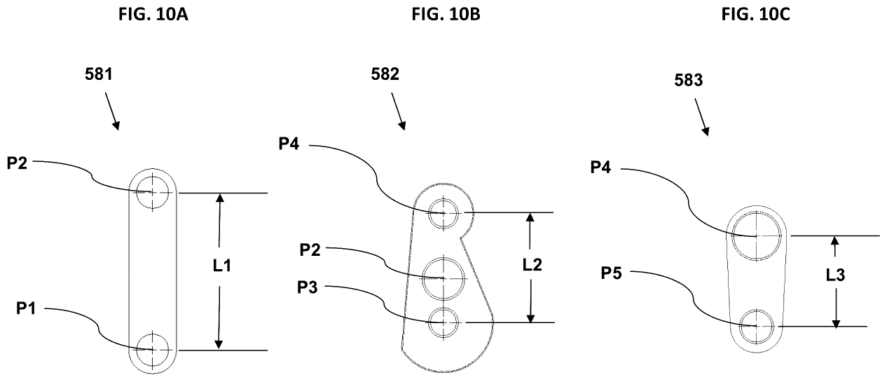

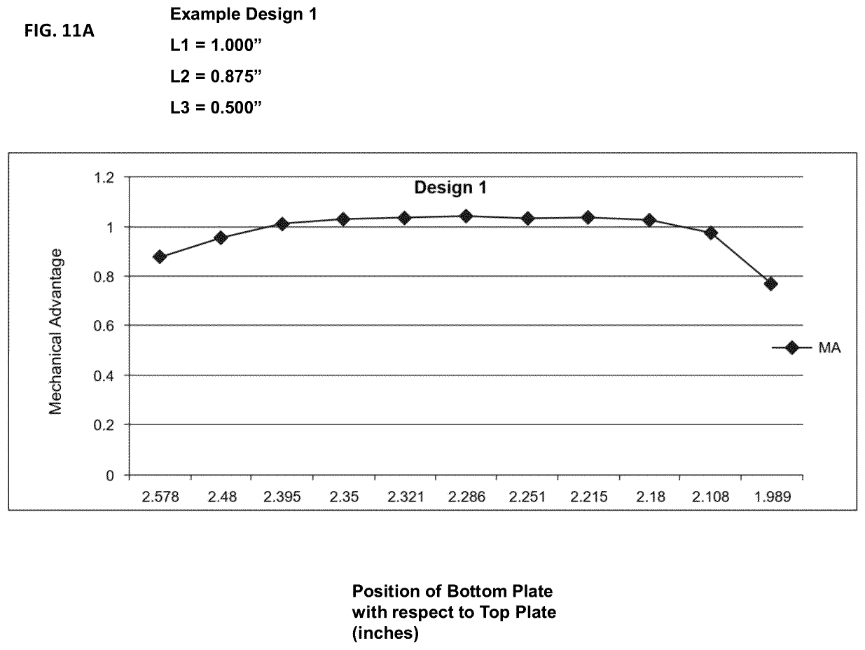

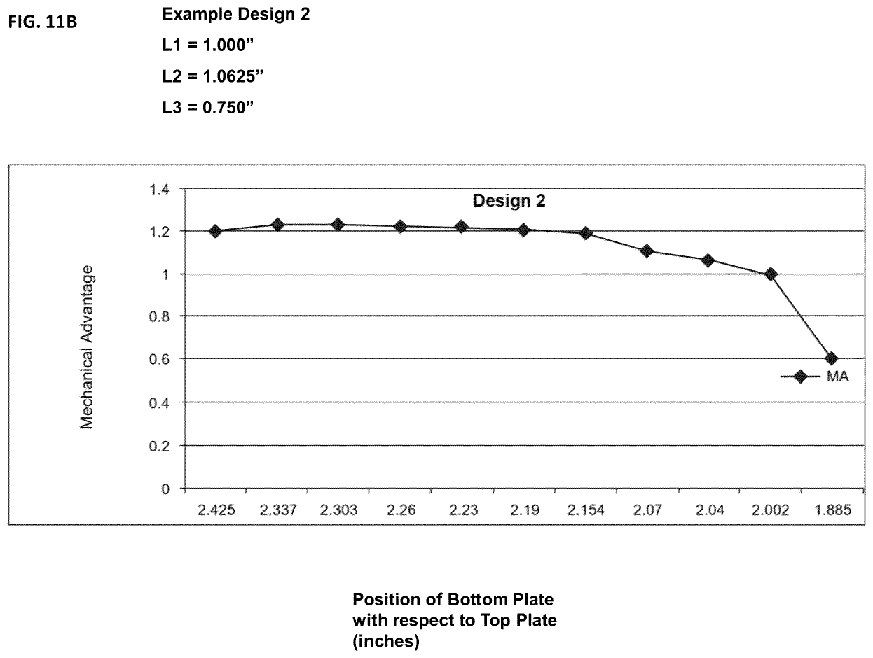

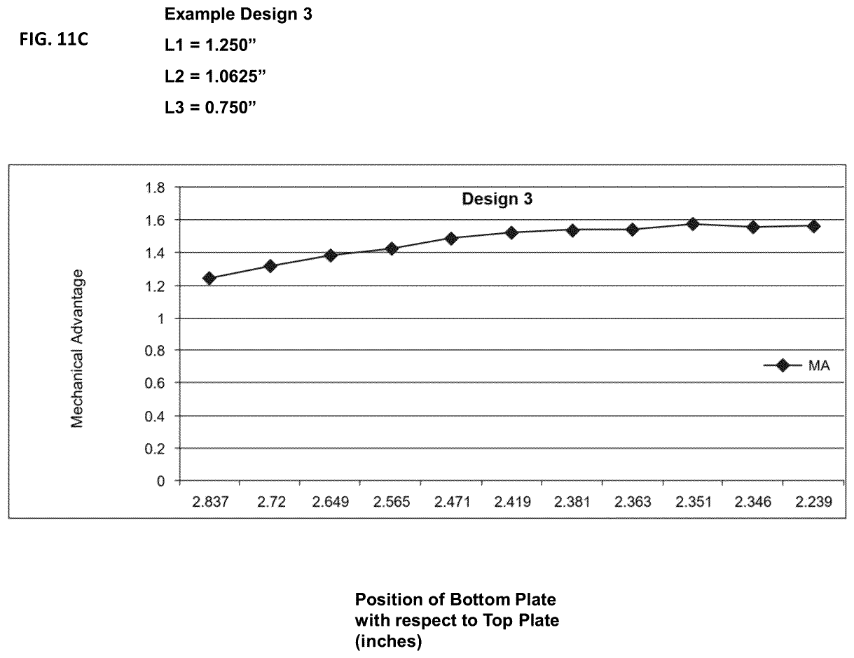

With a design as shown in FIG. 9, which includes three links, levers, or linkages 581, 582, 583, a wide variety of mechanical advantage curves may be achievable within the same or similar overall envelope size of the spring actuator assembly 541, such as by altering the locations of one or more of the pivot axes, changing distances between one or more of the pivot axes, changing the lengths or heights of the various couplers 591, 592, 593, and/or the like. For example, FIGS. 11A, 11B, and 11C illustrate three examples of different mechanical advantage curves that can be achieved with embodiments similar to the spring actuator assembly 541 of FIG. 7A, but with varying lengths of the links or linkages 581, 582, 583. Specifically, FIGS. 10A, 10B, and 10C illustrate side views of the first link 581, second link 582, and third link 583, respectively. These figures utilize the same pivot axis reference numbers as used in FIG. 9 to indicate the same pivot axes defined by the various spring actuator assembly components. FIGS. 10A-10C also illustrate example lengths that may be defined by each of the links. For example, FIG. 10A illustrates a length L1 of the first link 581, defined as a distance between pivot axes P1 and P2, measured perpendicular to pivot axes P1 and P2. FIG. 10B illustrates a length L2 of the second link 582, defined as a distance between pivot axes P3 and P4, measured perpendicular to pivot axes P3 and P4. FIG. 10C illustrates a length L3 of the third link 583, defined as a distance between pivot axes P4 and P5, measured perpendicular to pivot axes P4 and P5.

Turning to FIGS. 11A-11C, these figures illustrate example mechanical advantage curves created by varying the lengths L1, L2, and/or L3 shown in FIGS. 10A-10C. Turning to FIG. 11A, this figure illustrates a mechanical advantage curve based on a first example design, wherein length L1 is 1.000 inches, length L2 is 0.875 inches, and length L3 is 0.500 inches. The x-axis of the graph shows the relative position of the bottom plate (such as bottom plate 544 of FIG. 7A) with respect to the top plate (such as top plate 504 of FIG. 7A), in inches. The y-axis shows the mechanical advantage at each position of the bottom plate. The start of the mechanical advantage curve (e.g., at 2.578 inches on the x-axis), corresponds to the fully extended configuration of the spring actuator assembly (such as the configuration shown in FIG. 7C), and the end of the mechanical advantage curve (e.g., at 1.989 inches on the x-axis), corresponds to the fully retracted or compressed configuration of the spring actuator assembly (such as the configuration shown in FIG. 7D). As can be seen with this design, the mechanical advantage starts out less than one (e.g., at a value of about 0.9), moves to greater than one while the spring actuator assembly is being compressed, and then back below one (e.g., to a value of about 0.75) in the fully compressed position.

Turning to FIG. 11B, this figure illustrates a second example design wherein length L1 is still 1.000 inches, length L2 has been increased to 1.0625 inches, and length L3 has been increased to 0.750 inches. With this modification to the design, it can be seen that the mechanical advantage curve remains above one throughout most of the stroke, with the mechanical advantage only dropping below one toward the end of the stroke (e.g., toward the fully compressed or retracted configuration of the spring actuator assembly). For example, the mechanical advantage starts at approximately 1.2 and ends at approximately 0.6.

Turning to FIG. 11C, this figure illustrates a third example design wherein length L1 has been increased to 1.250 inches, and lengths L2 and L3 are the same as with design 2 (wherein length L2 is 1.0625 inches and length L3 is 0.750 inches). With this modification to the design, it can be seen that the mechanical advantage curve remains above one throughout the entire stroke, starting at about 1.25 in the extended configuration, and ending at about 1.55 in the compressed or retracted configuration. It should be noted that the example mechanical advantage curves shown in FIGS. 11A-11C are merely three examples, and various other modifications to the spring actuator assembly 541 (and/or to the linkage assemblies 540) may be made in order to generate various mechanical advantage curves.

Returning to FIGS. 7A-7D, it should be noted that the spring actuator assembly 541 includes four shoulder bolts 572, four springs 110, and two linkage assemblies 540. The concepts disclosed herein are not limited to such a configuration, however, and various other designs may include more or fewer shoulder bolts 572, springs 110, and/or linkage assemblies 540. Further, components other than shoulder bolts could be used to enable the sliding arrangement of the bottom plate 544 and middle plate 545 with respect to top plate 504. The design illustrated in these figures has been found to be a relatively robust and efficiently manufacturable design, however.

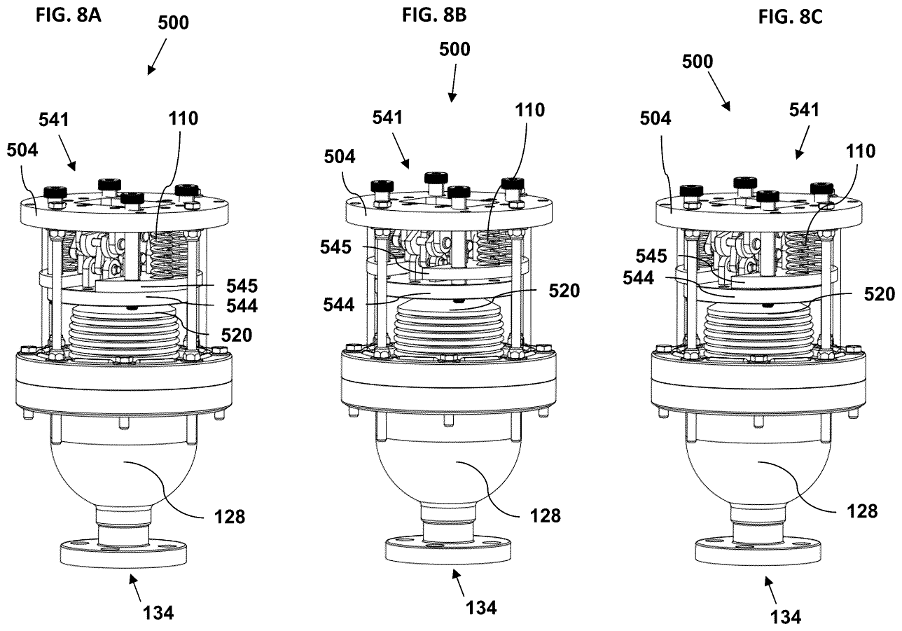

Turning to FIGS. 8A, 8B, and 8C, these figures are partial perspective views of the fluid pulsation dampener 500, with several portions of the fluid pulsation dampener 500 shown transparent, in order to show various configurations of the spring actuator assembly 541. In FIG. 8A, there is no fluid pressure in fluid chamber 128, and thus the springs 110 are fully extended, putting both the bottom plate 544 and the middle plate 545 of the spring actuator assembly 541 in their lowest positions. This corresponds to the fully extended configuration of spring actuator assembly 541 (and/or the fully extended configuration of the linkage assemblies 540). In FIG. 8B, fluid pressure has been applied in fluid chamber 128, causing pressure to be applied from the upper end of the bellows 520 to the bottom plate 544 of the spring actuator assembly 541, which causes the springs 110 to compress and the middle plate 545 to move upward. It should be noted that the bottom plate 544 has also moved upward, but due to the mechanical advantage provided by the linkage assemblies 540, the middle plate 545 moves upward faster or more than the bottom plate 544. In FIG. 8B, the bottom plate 544 and the middle plate 545 of the spring actuator assembly 541 are in their highest positions. This corresponds to the fully compressed or retracted configuration of spring actuator assembly 541 (and/or the fully compressed or retracted configuration of the linkage assemblies 540). Finally, FIG. 8C illustrates an intermediate configuration, where the fluid pressure in fluid chamber 128 has been reduced, and thus the springs 110 force the middle plate 545 downward, which in turn forces the bottom plate 544 downward, although at a lower speed than the middle plate 545 is moving downward. It should be noted that, in each of FIGS. 8A, 8B, and 8C, the bellows 520 is shown in its fully retracted configuration (e.g., corresponding to the fully extended configuration of the spring actuator assembly 541 shown in FIG. 8A). In reality, the bellows 520 would be at least somewhat expanded in the configurations shown in FIGS. 8B and 8C (e.g., expanded sufficiently that upper end 524 of the bellows 520 remains in contact with the bottom plate 544 of the spring actuator assembly 541).

### Additional Example Fluid Pulsation Dampener Embodiment

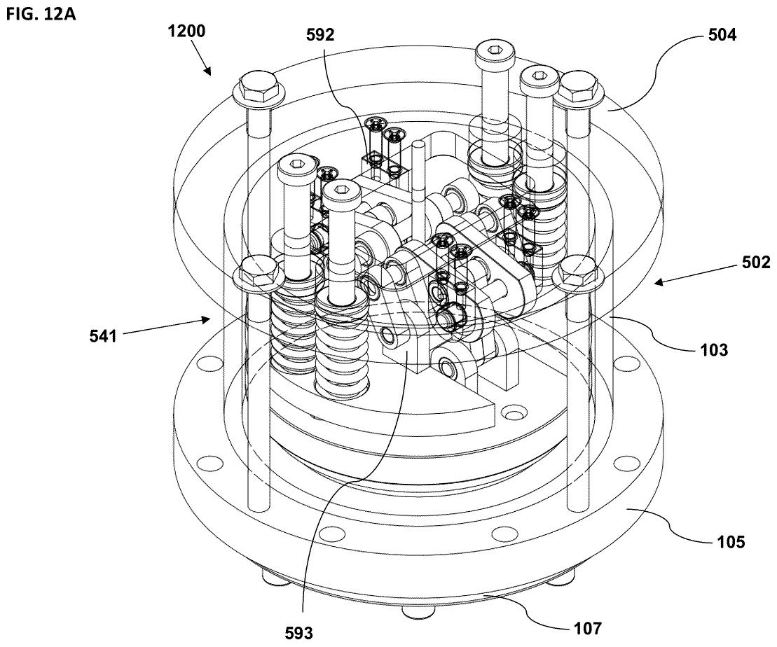

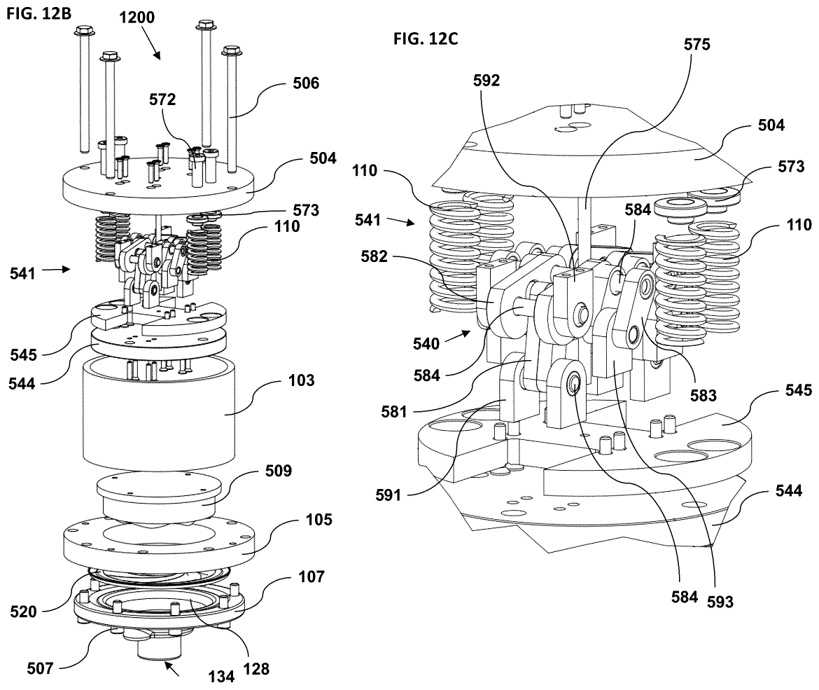

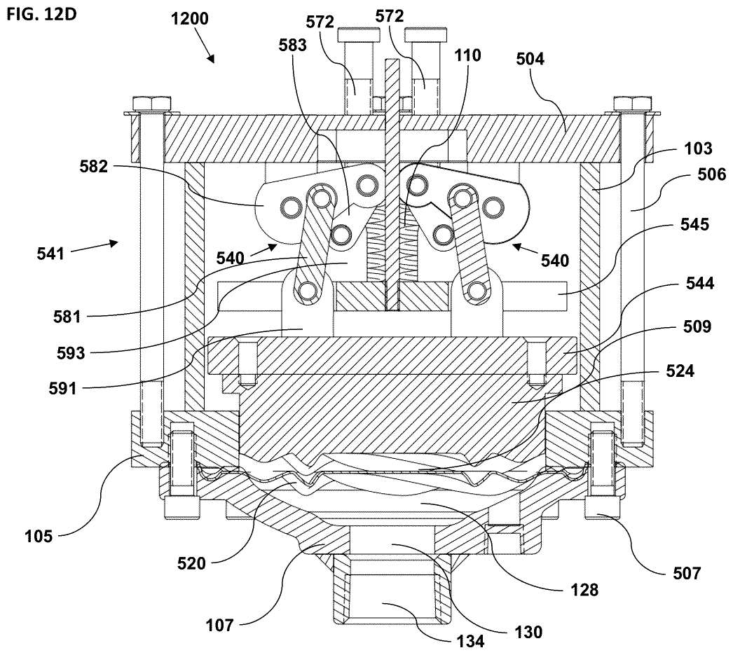

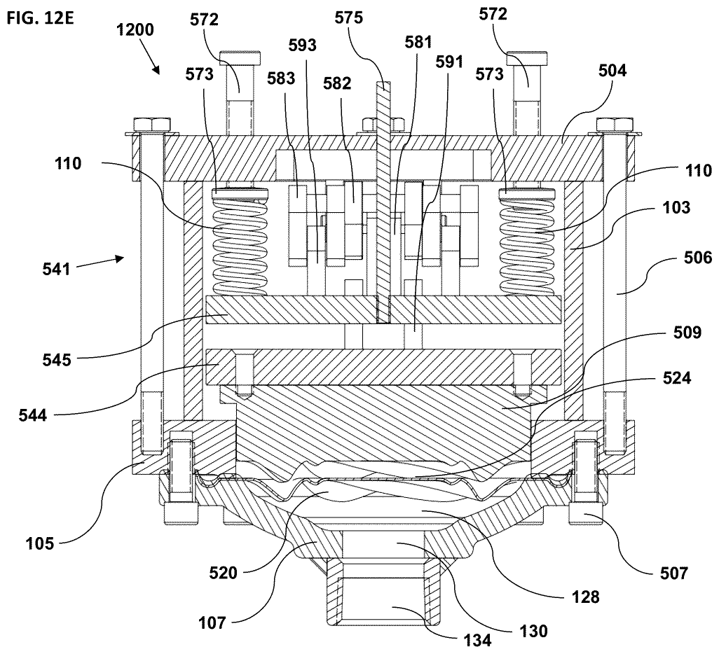

FIGS. 12A-15B illustrate another embodiment of a fluid pulsation dampener 1200 that incorporates many similar features and functionality as other pulsation dampeners disclosed herein. For example, the fluid pulsation dampener 1200 includes many of the same or similar components as the fluid pulsation dampener 500 described above, and the same or similar reference numbers are used to refer to the same or similar components. The fluid pulsation dampener 1200 may also operate similarly to the fluid pulsation dampener 500 described above, and any description above related to the fluid pulsation dampener 500 may also apply to the fluid pulsation dampener 1200.

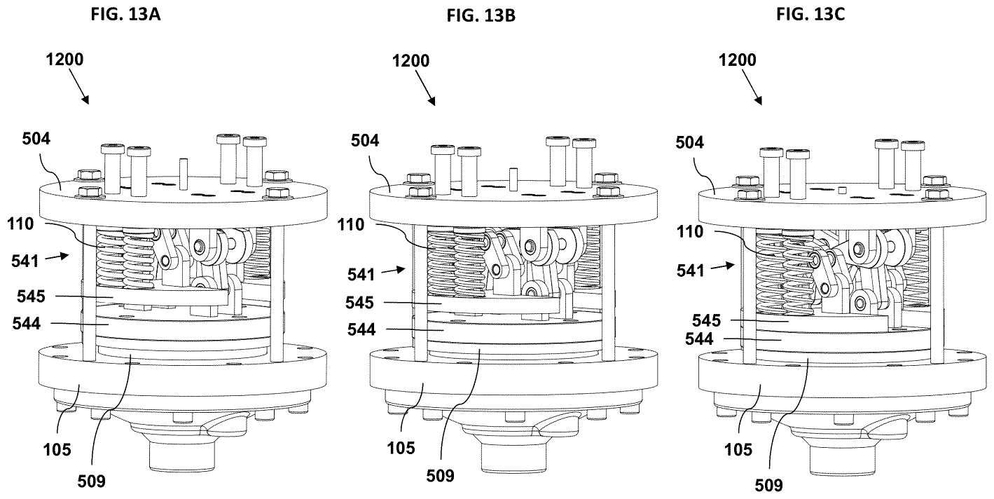

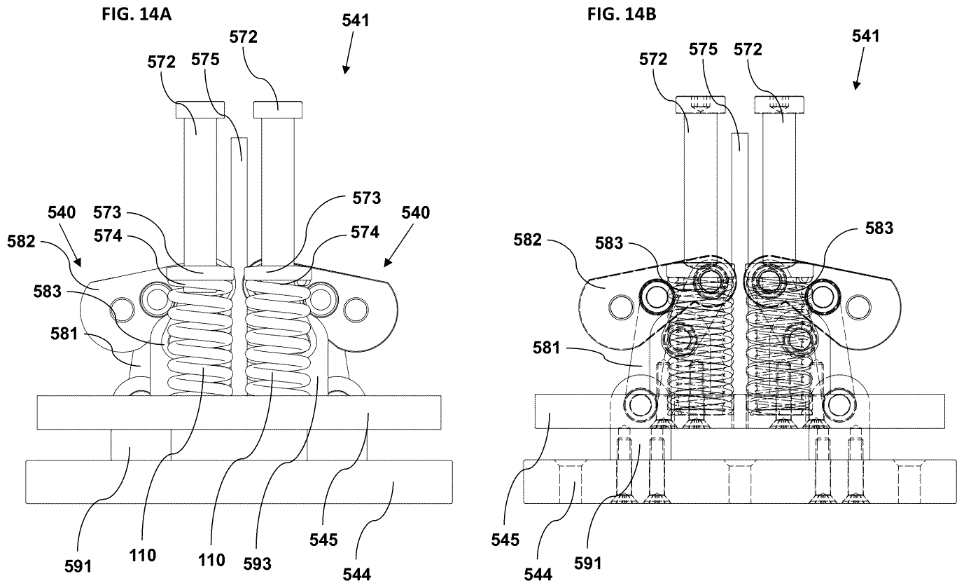

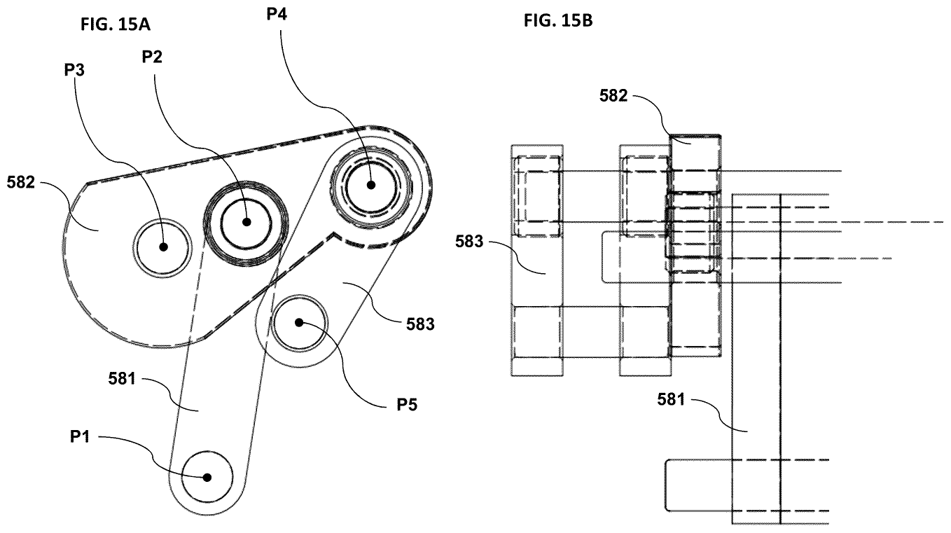

FIG. 12A is a perspective view of the fluid pulsation dampener 1200, with various portions of the fluid pulsation dampener 1200 being shown transparent in order to illustrate more detail of the internal components. FIG. 12B is an exploded view of the fluid pulsation dampener 1200, and FIG. 12C is an enlarged view of a portion of the exploded view of FIG. 12B. FIGS. 12D and 12E are cross-sectional views of the pulsation dampener 1200, each taken through a different section plane. FIGS. 13A, 13B, and 13C are perspective views of the fluid pulsation dampener 1200, with its spring actuator assembly 541 shown in a compressed or retracted configuration, an intermediate configuration, and an extended configuration, respectively. FIG. 14A is a side view of the spring actuator assembly 541, and FIG. 14B is a similar side view, but with various components shown in hidden lines to show portions that are not visible in FIG. 14A. FIGS. 15A and 15B are side views of a portion of the spring actuator assembly 541, viewed from different angles.

With reference to FIGS. 12A and 12B, the fluid pulsation dampener 1200 comprises a housing 502 that includes an upper or first portion 103, a middle or second portion 105, and a lower or third portion 107. The lower portion 107 of the housing 502 desirably comprises a fluid chamber 128 that is in fluid communication with a fluid port 134 through a fluid flow channel 130 (see FIGS. 12D & 12E). In this embodiment, like pulsation dampener 500, the pulsation dampener 1200 comprises a single fluid port 134 that acts as both the inlet and outlet, which is different than pulsation dampener 100 described above, which includes two fluid ports 134, 135.

With continued reference to FIGS. 12A and 12B, the upper portion 103 of the housing 502, and a top plate 504, are shown partially transparent in FIG. 12A, in order to show some internal features of the pulsation dampener 1200. For example, various portions of the spring actuator assembly 541 can be seen in FIG. 12A. One notable difference in the fluid pulsation dampener 1200 as compared to the fluid pulsation dampener 500 is that the deformable member 520 of the fluid pulsation dampener 1200 is desirably a diaphragm instead of a bellows. The deformable member 520 of the fluid pulsation dampener 1200 can operate similarly to the other deformable members described herein.

With reference to FIGS. 12B-12E, positioned above the deformable member 520 is a spring actuator assembly 541 that comprises a plurality of springs 110 configured to resist the upward movement of the upper end 524 of the deformable member 520 and/or of the top or plate 509 engaged with the deformable member 520. The spring actuator assembly 541 comprises a bottom plate 544 that desirably engages the upper end 524 of the deformable member 520 and/or the top or plate 509. The plate 509 may desirably comprise polypropylene, PVC, and/or another material that may help to, for example, reduce wear or damage to the deformable member 520. When pressure is increased within the fluid chamber 128, the upper end 524 of the deformable member 520 (and the top or plate 509) will desirably move upward, thus also moving bottom plate 544 of the spring actuator assembly 541 upward with respect to top plate 504 of the spring actuator assembly 541. As the bottom plate 544 is moved upward with respect to top plate 504, the plurality of springs 110 are compressed (via the plurality of linkage assemblies 540), thus providing a resistance to the upward movement of bottom plate 544.

With continued reference to FIGS. 12B-12E, the fluid pulsation dampener 1200 further comprises a plurality of screws 506 that pass through the top plate 504 of the spring actuator assembly 541, and into the middle portion 105 of the housing 502, in order to retain the spring actuator assembly 541 in place with respect to the rest of the fluid pulsation dampener 1200. The fluid pulsation dampener 1200 also includes a plurality of additional fasteners 507, in this case screws, which retain the bottom portion 107 of the housing to the middle portion 105 of the housing.

With reference to FIGS. 12B, 12C, 14A, and 14B, the spring actuator assembly 541 of fluid pulsation dampener 1200 comprises a first member, such as a top plate 504, that has a plurality of bolts 572 (in this case four) passing therethrough and threadedly engaged with the top plate 504. Unlike the pulsation dampener 500 design, the bolts 572 of pulsation dampener 1200 desirably engage the springs 110 instead of the bottom plate 544. More specifically, the bolts 572 desirably engage spring seats 573, which engage upper ends 574 of the springs 110. The bolts 572 can desirably be adjusted up or down with respect to the top plate 504, in order to adjust an amount of preload on the springs 110.

In order to resist upward movement of the bottom plate 544 with respect to the top plate 504, a plurality of springs 110 (in this case four) are positioned between the top plate 504 and bottom plate 544. If the springs 110 directly acted on both the top plate 504 and bottom plate 544, however, there would be no mechanical advantage created between the top plate 504 and bottom plate 544, and the disadvantages of such a design discussed above would apply. In the fluid pulsation dampener 1200, however, the plurality of springs 110 do not act directly on both the top plate 504 and bottom plate 544. In this embodiment, upper ends of the springs 110 are coupled to the top plate 504 (such as via spring seats 573 and bolts 572, as described above), but lower ends of the springs 110 apply force to the bottom plate 544 through a third member, such as middle plate 545, and a plurality of linkage assemblies 540, instead of acting directly on the bottom plate 544. Specifically, the lower ends of the springs 110 are coupled to and/or engage the middle plate 545, which is slidably coupled to the top plate 504 via a shaft 575, and can translate or slide along the axis of the shaft 575 with respect to both the top plate 504 and the bottom plate 544. The middle plate 545 is further mechanically linked to both the top plate 504 and the bottom plate 544 through a series of links or linkages of two linkage assemblies 540, including first links 581, second links 582, and third links 583. FIGS. 15A and 15B illustrate more details of the links 581, 582, 583. Like the pulsation dampener 500, the links 581, 582, 583 of the pulsation dampener 1200 can desirably be pivotally coupled together using a plurality of components 584 that may include, for example, pins, busing, bearings, and/or the like.

With continued reference to FIGS. 12C-12E and 14A-14B, the spring actuator assembly 541 desirably comprises two linkage assemblies 540. Each of the linkage assemblies 540 desirably comprises one first link 581 and one second link 582, with the first link 581 pivotally coupling the bottom plate 544 to the second link 582. More specifically, couplers 591 are rigidly attached to bottom plate 544 and define pivot axis P1 (see FIG. 15A) that a first end of first link 581 can pivot about. Further, with reference to FIG. 15A, a second end of first link 581 is pivotally coupled at pivot axis P2 to a middle portion of the second link 582.

A first end of the second link 582 of each linkage assembly 540 is desirably pivotally coupled to a pair of couplers 592 at pivot axis P3 (see FIG. 15A), with the couplers 592 being rigidly attached to the top plate 504 (see FIGS. 12A and 12C). Next, the opposite end of each of the second links 582 is desirably pivotally coupled at pivot axis P4 (see FIG. 15A) with a first end of each of two third links 583. The third links 583 are each in turn desirably pivotally coupled at their other end at pivot axis P5 (see FIG. 15A) to a coupler 593 that is rigidly attached to the middle plate 545 (see FIGS. 12A & 12C). The various pivot axes shown in FIG. 15A may take various mechanical forms, such as utilizing bushings, bearings, pins within holes without bushings or bearings, and/or the like.

With continued reference to FIGS. 12C-12E, 14A-14B, and 15A-15B, an upward force on the bottom plate 544 (such as may be applied by the top or plate 509 shown in FIG. 12B) will cause the first link 581 to press upward on the second link 582 at pivot axis P2. Because pivot axis P3 is rigidly located with respect to the top plate 504, this force will cause pivot axis P4 at the other end of the second link 582 to move upward. The movement of pivot axis P4 upward will in turn cause third link 583 and pivot axis P5 to be pulled upward. This will in turn cause the middle plate 545 to move upward, thus compressing the springs 110 between the middle plate 545 and the top plate 504, and resisting upward movement of the bottom plate 544.

With a design as shown in FIG. 15A, which includes three links, levers, or linkages 581, 582, 583, a wide variety of mechanical advantage curves may be achievable within the same or similar overall envelope size of the spring actuator assembly 541, such as by altering the locations of one or more of the pivot axes, changing distances between one or more of the pivot axes, changing the lengths or heights of the various couplers 591, 592, 593, and/or the like. For example, the same examples discussed above with reference to FIGS. 11A, 11B, and 11C can apply to the pulsation dampener 1200, with lengths between pivots shown in FIGS. 10A-10C applying similarly to the links of FIG. 15A.

Similar to as discussed above with reference to the pulsation dampener 500, it should be noted that the spring actuator assembly 541 of pulsation dampener 1200 includes four bolts 572, four springs 110, one guide or shaft 575, and two linkage assemblies 540. The concepts disclosed herein are not limited to such a configuration, however, and various other designs may include more or fewer bolts 572, springs 110, shafts 575, and/or linkage assemblies 540. Further, components other than the shaft 575 could be used to guide the sliding arrangement of the middle plate 545 with respect to top plate 504. The design illustrated in these figures has been found to be a relatively robust and efficiently manufacturable design, however.

Turning to FIGS. 13A, 13B, and 13C, these figures are perspective views of the fluid pulsation dampener 1200, with the upper portion 103 of the house removed, in order to show various configurations of the spring actuator assembly 541. In FIG. 13C, there is no fluid pressure in fluid chamber 128 (see FIG. 12D), and thus the springs 110 are fully extended, putting both the bottom plate 544 and the middle plate 545 of the spring actuator assembly 541 in their lowest positions. This corresponds to the fully extended configuration of spring actuator assembly 541 (and/or the fully extended configuration of the linkage assemblies 540). In FIG. 13A, fluid pressure has been applied in fluid chamber 128, causing pressure to be applied from the upper end of the deformable member 520 to the top or plate 509 and thus to the bottom plate 544 of the spring actuator assembly 541, which causes the springs 110 to compress and the middle plate 545 to move upward. It should be noted that the bottom plate 544 has also moved upward, but due to the mechanical advantage provided by the linkage assemblies 540, the middle plate 545 moves upward faster or more than the bottom plate 544. In FIG. 13A, the bottom plate 544 and the middle plate 545 of the spring actuator assembly 541 are in their highest positions. This corresponds to the fully compressed or retracted configuration of spring actuator assembly 541 (and/or the fully compressed or retracted configuration of the linkage assemblies 540). Finally, FIG. 13B illustrates an intermediate configuration, where the fluid pressure in fluid chamber 128 has been reduced, and thus the springs 110 force the middle plate 545 downward, which in turn forces the bottom plate 544 downward, although at a lower speed than the middle plate 545 is moving downward.

### Additional Information

Various other modifications, adaptations, and alternative designs are of course possible in light of the above teachings. Therefore, it should be understood at this time that within the scope of the appended claims the invention may be practiced otherwise than as specifically described herein. It is contemplated that various combinations or subcombinations of the specific features and aspects of the embodiments disclosed above may be made and still fall within one or more of the inventions. Further, the disclosure herein of any particular feature, aspect, method, property, characteristic, quality, attribute, element, or the like in connection with an embodiment can be used in all other embodiments set forth herein. Accordingly, it should be understood that various features and aspects of the disclosed embodiments can be combined with or substituted for one another in order to form varying modes of the disclosed inventions. Thus, it is intended that the scope of the present inventions herein disclosed should not be limited by the particular disclosed embodiments described above. Moreover, while the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents, and alternatives falling within the spirit and scope of the various embodiments described and the appended claims. Any methods disclosed herein need not be performed in the order recited.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. The headings used herein are for the convenience of the reader only and are not meant to limit the scope of the inventions or claims.

What is claimed is:

1. A pulsation dampener comprising:
a housing having one or more fluid ports for fluidly coupling the pulsation dampener to a fluid pumping system,
the housing further comprising a fluid chamber in fluid communication with the one or more fluid ports;
a diaphragm having a first side and a second side, the first side of the diaphragm being in fluid communication with the fluid chamber such that changes in pressure in the fluid chamber can cause the diaphragm to deform;
a mechanical spring positioned within a cavity of the housing, the mechanical spring having a first end and a second end, the first end of the mechanical spring being engaged with an adjustment screw that is translatable along a length of the cavity of the housing to adjust a level of preload on the mechanical spring; and
a linkage assembly coupling the diaphragm to the second end of the mechanical spring, the linkage assembly comprising:
a diaphragm seat coupled to the second side of the diaphragm;
a spring seat coupled to the second end of the mechanical spring; and
a linkage that is pivotally coupled to the housing at a first pivot location, to the diaphragm seat at a second pivot location, and to the spring seat at a third pivot location,
wherein a distance between the second pivot location and the first pivot location is greater than a distance between the third pivot location and the first pivot location, such that translation of the diaphragm seat with respect to the housing by a first magnitude will cause translation of the spring seat with respect to the housing by a second magnitude that is smaller than the first magnitude.

2. A pulsation dampener comprising:
a housing having one or more fluid ports for fluidly coupling the pulsation dampener to a fluid pumping system,
the housing further comprising a fluid chamber in fluid communication with the one or more fluid ports;
a deformable member having a first side and a second side, the first side of the deformable member being in fluid communication with the fluid chamber such that changes in pressure in the fluid chamber can cause the deformable member to deform;
a spring having a first end and a second end; and
a linkage assembly coupling the deformable member to the second end of the spring, the linkage assembly comprising:
a first member coupled to the second side of the deformable member;
a second member coupled to the second end of the spring; and
a linkage that is pivotally coupled to the housing at a first pivot location, to the first member at a second pivot location, and to the second member at a third pivot location,
wherein a distance between the second pivot location and the first pivot location is different than a distance between the third pivot location and the first pivot location, such that translation of the first member with respect to the housing by a first magnitude will cause translation of the second member with respect to the housing by a second magnitude that is different than the first magnitude.

3. The pulsation dampener of claim 2, wherein the deformable member comprises a diaphragm.

4. The pulsation dampener of claim 2, wherein the spring comprises a mechanical spring.

5. The pulsation dampener of claim 2, wherein the spring does not comprise pressurized gas.

6. The pulsation dampener of claim 2, wherein the first end of the spring is coupled to an adjuster that enables adjustment of a level of preload on the spring.

7. The pulsation dampener of claim 2, wherein the distance between the second pivot location and the first pivot location is greater than the distance between the third pivot location and the first pivot location, such that the second magnitude will be less than the first magnitude.

8. The pulsation dampener of claim 2, wherein the distance between the second pivot location and the first pivot location is less than the distance between the third pivot location and the first pivot location, such that the second magnitude will be greater than the first magnitude.

9. A pulsation dampener comprising:
a housing having a fluid port and a fluid chamber that is in fluid communication with the fluid port;
a deformable member that is in fluid communication with the fluid chamber, such that the deformable member at least partially defines a volume of the fluid chamber, and such that the deformable member will deform responsive to pressure changes within the fluid chamber; and
a spring actuator assembly that resists deformation of the deformable member in a direction that increases the volume of the fluid chamber, the spring actuator assembly comprising:
a top plate that is fixed with respect to the housing;
a bottom plate that is translatable with respect to the top plate, the bottom plate being engaged directly or indirectly with the deformable member such that deformation of the deformable member will cause translation of the bottom plate with respect to the top plate;
a middle plate positioned between the top plate and the bottom plate, the middle plate being translatable with respect to both the top plate and the bottom plate;
a plurality of springs positioned between the top plate and the middle plate, the plurality of springs providing a biasing force that biases the middle plate away from the top plate; and
a plurality of linkage assemblies each comprising:
a first link having a first end and a second end, the first end of the first link being pivotally coupled to the bottom plate;
a second link having a first end and a second end, the first end of the second link being pivotally coupled to the top plate, and the second end of the first link being pivotally coupled to a portion of the second link between the first and second ends of the second link; and
a third link having a first end and a second end, the first end of the third link being pivotally coupled to the second end of the second link, and the second end of the third link being pivotally coupled to the middle plate;
wherein the plurality of linkage assemblies are configured such that translation of the bottom plate with respect to the top plate of a first magnitude will result in translation of the middle plate with respect to the top plate of a second magnitude, the second magnitude being greater than the first magnitude.

10. The pulsation dampener of claim 9, wherein the deformable member comprises a bellows.

11. The pulsation dampener of claim 9, wherein the deformable member comprises a diaphragm.

12. A pulsation dampener comprising:
a housing having a fluid port and a fluid chamber that is in fluid communication with the fluid port;
a deformable member that is in fluid communication with the fluid chamber, such that the deformable member will deform responsive to pressure changes within the fluid chamber; and
a spring actuator assembly comprising:
a first member connected to the housing;
a second member that is translatable with respect to the first member, the second member being positioned such that deformation of the deformable member will cause translation of the second member with respect to the first member;
a third member that is translatable with respect to both the first member and the second member;
one or more springs positioned to provide a biasing force between the first member and the third member; and
one or more linkage assemblies pivotally coupled to the first member, the second member, and the third member, the one or more linkage assemblies being configured such that translation of the second member with respect to the first member of a first magnitude will result in translation of the third member with respect to the first member of a second magnitude, the second magnitude being different than the first magnitude.

13. The pulsation dampener of claim 12, wherein the deformable member comprises a bellows.

14. The pulsation dampener of claim 12, wherein the deformable member comprises a diaphragm.

12. The pulsation dampener of claim 12, wherein the third member is positioned between the first member and the second member.

16. The pulsation dampener of claim 12, wherein the one or more springs are positioned to bias the third member toward the deformable member.

17. The pulsation dampener of claim 12, wherein the one or more springs comprise mechanical springs.

18. The pulsation dampener of claim 12, wherein the one or more springs do not comprise pressurized gas.

19. The pulsation dampener of claim 12, wherein the one or more linkage assemblies each comprise:
a first link pivotally coupled to the second member;
a second link pivotally coupled to the first member and the first link; and
a third link pivotally coupled to the second link and the middle plate.

20. The pulsation dampener of claim 12, wherein the second magnitude is greater than the first magnitude.

21. The pulsation dampener of claim 12, wherein the one or more linkage assemblies are configured such that a relationship between translation of the second member with respect to the first member and translation of the third member with respect to the first member is non-linear.

22. A pulsation dampener comprising:
a housing having a fluid port and a fluid chamber that is in fluid communication with the fluid port;
a deformable member in fluid communication with the fluid chamber;
a spring; and
a linkage assembly that transfers a force between the deformable member and the spring, wherein the linkage assembly is configured to amplify the force between the deformable member and the spring.

23. The pulsation dampener of claim 22, wherein the force amplified by the linkage assembly is a force applied to the linkage assembly directly or indirectly by the spring.

24. The pulsation dampener of claim 22, wherein the force amplified by the linkage assembly is a force applied to the linkage assembly directly or indirectly by the deformable member.

25. The pulsation dampener of claim 22, wherein the linkage assembly comprises a first member that transfers the force to the spring, a second member that transfers the force to the deformable member, and one or more linkages that transfer the force between the first member and the second member.

26. The pulsation dampener of claim 25, wherein the one or more linkages are configured to provide a mechanical advantage between the first member and the second member.

27. The pulsation dampener of claim 22, wherein the deformable member comprises a diaphragm.

28. The pulsation dampener of claim 22, wherein the deformable member comprises a bellows.

29. The pulsation dampener of claim 22, further comprising at least one additional spring and at least one additional linkage assembly.

30. The pulsation dampener of claim 22, wherein the linkage assembly is configured such that a magnitude of amplification of the force between the deformable member and the spring varies depending on a position of the deformable member.
